(19) United States
(12) Patent Application Publication
(10) Pub. No.: US 2026/0186321 A1
(43) Pub. Date: Jul. 2, 2026

(54) AIR FLOATING VIDEO INFORMATION DISPLAY SYSTEM

(71) Applicant: Maxell, Ltd., Kyoto (JP)

(72) Inventors: Koji HIRATA, Kyoto (JP); Toshinori SUGIYAMA, Kyoto (JP); Koji FUJITA, Kyoto (JP)

(21) Appl. No.: 18/868,345

(22) PCT Filed: Mar. 20, 2023
(86) PCT No.: PCT/JP2023/011013

§ 371 Date: Nov. 22, 2024

(30) Foreign Application Priority Data
May 25, 2022 (JP) 2022-085273

(51) Int. Cl. G02B 30/56; G02B 27/28

(52) U.S. Cl. CPC G02B 30/56; G02B 27/283

(57) ABSTRACT

A video is preferably displayed outside of a space in a way that contributes to “the third goal: Good Health and Well-being (for all people)”, “the ninth goal: Industry, Innovation and Infrastructure” and “the eleventh goal: Sustainable Cities and Communities” of the sustainable development goals. An air floating video information display system includes: a display panel to display a video; a light source for the display panel; a retroreflector configured to reflect video light emitted from the display panel and to cause the reflected light to aerially display an air floating video of a real image; and a light-transmittable plate including a reflection-type polarizer configured to convert an optical path of the video light. The light-transmittable plate is arranged between the retroreflector and the display panel, and an attachment angle of an optical member and a position of the display panel are adjusted for positioning the air floating video.

### TECHNICAL FIELD

The present invention relates to an air floating video information display system and an optical system used therefor.

### BACKGROUND ART

A video display apparatus configured to directly display a video toward outside and a display method of displaying it as an air (space) screen have been already known as an air floating information display system. Also, a sensing system for reducing erroneous sensing of an operation of a displayed air video on an operation surface has been also disclosed in, for example, a Patent Document 1.

### RELATED-ART DOCUMENT

### Patent Document

Patent Document 1: Japanese Patent Application Laid-open Publication No. 2019-128722

### SUMMARY OF THE INVENTION

### Problems to be Solved by the Invention

A video display apparatus configured to directly display a video toward outside and a display method of displaying it as an air (space) screen have been already known as an air floating information display system. However, the related-art air floating video information display system is not provided while taking into account a means for preventing failures from occurring when external light enters a retroreflector configured to form an air floating video, and a technique for optimal design of the air floating information display system including an air video information display unit capable of setting a display position of the air floating video as client's needed, a sensing system for aerially operating the display video, and a light source of a video display apparatus serving as a video source of the air floating video.

An objective of the present invention relates to an air floating information display system or an air floating information display apparatus, and is to provide a unit structure capable of displaying an air floating video with high visual recognition (resolution and contrast in viewing) and less influence of external light and capable of changing a display position of the air floating video as client's needed, and to provide a method of accurately operating the display image and a technique capable of displaying a favorable video.

### Means for Solving the Problems

In order to solve the problems, for example, configurations described in a section <CLAIMS> are employed. The present application includes a plurality of means for solving the above problems, and an air floating video display apparatus as one of the means will be exemplified below. An air floating video information display system as one example of the present application includes a unit including: a display panel configured to display a video; a light source apparatus for the display panel; a retroreflector configured to reflect video light and to cause the reflected light to aerially display an air floating video of a real image; and an optical member configured to transmit the video light emitted from the display panel once, and then, reflect the video light reflected on the retroreflector including a λ/4 plate on its surface. A distance between the display panel and the optical member is configured to be changeable to display the air floating video at a desirable position in a front or back direction, and one end of the unit is configured to be rotatable to display the air floating video at a desirable position in an up or down direction.

### Effects of the Invention

According to the present invention, even if the external light enters, image quality of the air floating video does not decrease, and the air floating video information can be favorably displayed. Also, the display position of the air floating video can be optionally set. Further, operation input can be performed without direct touch with the display screen because of the air floating video display apparatus.

### BRIEF DESCRIPTIONS OF THE DRAWINGS

FIG. 1 is a principle diagram for explaining a principle and an issue of air floating video formation in an air floating video information display system of the present invention.

FIG. 2 is a diagram illustrating an appearance and a configuration of main components of an embodiment of an air floating video information display unit and illustrating a formation position of an air floating image according to one embodiment of the present invention.

FIG. 3 is an explanatory diagram for explaining an appearance of the air floating video information display system, the formation position of the air floating image, and vertical and horizontal viewing ranges according to one embodiment of the present invention.

FIG. 4 is a diagram illustrating an appearance and a configuration of main components of a second embodiment of another air floating video information display system according to one embodiment of the present invention.

FIG. 5 is an explanatory diagram for explaining a sensing means provided in the air floating video information display system according to one embodiment of the present invention.

FIG. 6 is a diagram illustrating other exemplary specific configuration of a light source apparatus according to one embodiment of the present invention.

FIG. 7A is a configuration diagram illustrating other exemplary specific configuration of the light source apparatus in other system.

FIG. 7B is a diagram illustrating part of other exemplary specific configuration of the light source apparatus in other system.

FIG. 7C is a diagram illustrating part of other exemplary specific configuration of the light source apparatus in other system.

FIG. 7D is a diagram illustrating part of other exemplary specific configuration of the light source apparatus in other system.

FIG. 8A is a configuration diagram illustrating other exemplary specific configuration of the light source apparatus in other system.

FIG. 8B is a diagram illustrating other exemplary specific configuration of the light source apparatus in other system.

FIG. 9 is an enlarged diagram illustrating a surface shape of other exemplary light-guiding-body diffuse portion in a specific configuration in the light source apparatus.

FIG. 10 is a cross-sectional view illustrating an exemplary specific configuration of the light source apparatus.

FIG. 11 is a configuration diagram illustrating an exemplary specific configuration of the light source apparatus.

FIG. 12 is a perspective view, a top view, and a cross-sectional view illustrating an exemplary specific configuration of the light source apparatus.

FIG. 13 is a perspective view and a top view illustrating an exemplary specific configuration of the light source apparatus.

FIG. 14 is an explanatory diagram for explaining a light-source diffuse property of a video display apparatus.

FIG. 15 is an explanatory diagram for explaining light-source diffuse property of the video display apparatus.

FIG. 16 is an explanatory diagram for explaining a diffuse property of the video display apparatus.

FIG. 17 is an explanatory diagram for explaining a diffuse property of the video display apparatus.

FIG. 18 is a diagram illustrating a coordinate system for measuring visual property of a liquid crystal panel.

FIG. 19 is a diagram illustrating luminance angle property (long-side direction) of a typical liquid crystal panel.

FIG. 20 is a diagram illustrating luminance angle property (short-side direction) of the typical liquid crystal panel.

FIG. 21 is a diagram illustrating contrast angle property (long-side direction) of the typical liquid crystal panel.

FIG. 22 is a diagram illustrating contrast angle property (short-side direction) of the typical liquid crystal panel.

### DETAILED DESCRIPTION OF PREFERRED EMBODIMENTS

Hereinafter, embodiments of the present invention will be explained in detail with reference to the drawings. Note that the present invention is not limited to contents of embodiments (also referred to as “present disclosure”) explained below. The present invention also covers the invention's spirit, the scope of the technical idea described in claims, or equivalents. The configuration of the embodiments (examples) explained below is only one example, and can be variously modified and altered within the scope of the technical idea disclosed in the present specification by the person skilled in the art.

The components having the same or similar function are denoted with the same reference sign through the drawings for explaining the present invention, and the different name is appropriately used. On the other hand, the repetitive explanation for the function and others may be omitted. In the following explanation for the embodiments, note that the floating image in air is expressed as a term “air floating image”. In place of this term, this may be expressed as “spatial image”, “air (aerial) image”, “spatial floating image”, “air floating optical image of display image”, “spatial floating optical image of display image” or others. The term “air floating image” mainly used in the explanation for the embodiments is used as a typical example of these terms.

The present disclosure relates to an information display system capable of, for example, transmitting a video based on video light emitted from a video light emission source having a large area, through a transparent member partitioning a space such as a glass of a show window or others, and displaying the video as the air floating video inside or outside a shop (space). Also, the present disclosure relates to a large-scale digital signage system made of a plurality of the information display systems.

According to the following embodiments, for example, high-resolution video information can be displayed above a glass surface of a show window or a light-transmittable plate member while floating in air. In this case, only normal reflection light can be efficiently reflected with respect the retroreflector by making a divergence angle of the emitted video light small, that is, be an acute angle, and unifying the video light to have a specific polarized wave. Therefore, the light use efficiency is high, and the ghost image occurring in addition to the main air floating image and the colored reflection light caused by the incident external light reflected on the retroreflector can be suppressed, the ghost image and the colored reflection light being the issues of 41 the related-art retroreflection system, and thus, a clear air floating video can be provided.

By an apparatus including the light source of the present disclosure, a new air floating image information display system being capable of significantly reducing power consumption and excellent in availability can be provided. A technique of the present disclosure can provide, for example, an in-vehicle floating video information display system being capable of displaying a visually-recognizable, that is, unidirectionality air floating video outside the vehicle through a shield glass including a front windshield glass, a rear windshield glass and a side windshield glass of the vehicle.

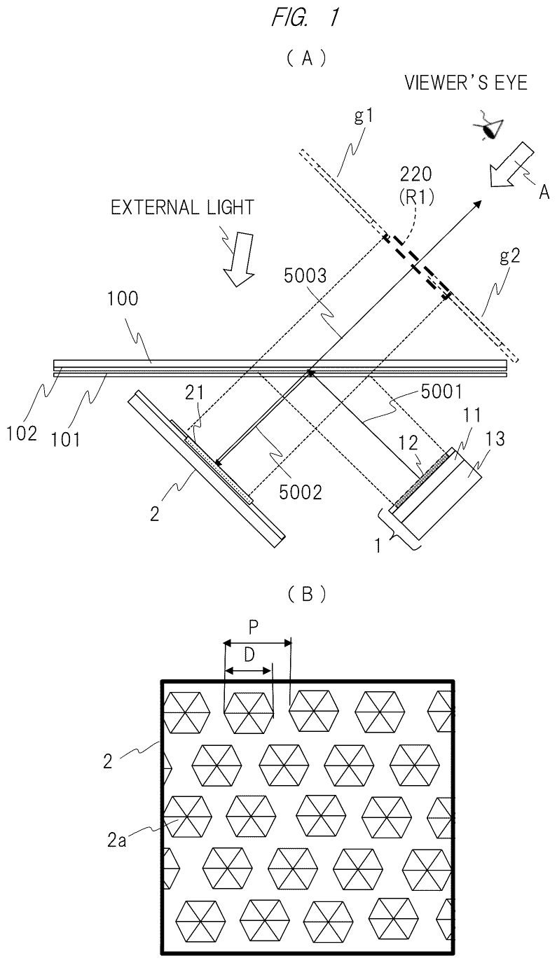

Meanwhile, in the related-art air floating video information display system, an organic EL panel or a liquid crystal display panel (liquid crystal panel or display panel) is combined with a retroreflector as a color-display video source having high resolution. In a first retroreflector 2 used in an air floating video display apparatus based on the related art, the video light diffuses at a wide angle, and therefore, a plurality of ghost images are formed by the video light that obliquely enters because a shape used for the retroreflector 2a is a hexahedron shape as illustrated in FIG. 1(B) in addition to the reflection light normally reflected on the retroreflector made of a polygonal body illustrated in FIG. 1(B) according to a first embodiment, and the ghost images reduce the image quality of the air floating video. Further, other person than the viewer is undesirably allowed to view the same air floating video that is the ghost image, and this case has a large problem in a viewpoint of security.

Next, functions of the retroreflector used in the air floating video display apparatus and specific embodiments of the air floating video display apparatus will be described. As illustrated in FIG. 1(A), the air floating image is formed by reflecting the light on a reflection-type light polarizer 101 for reflecting light of a specific polarized wave in a second light-transmittable plate 100 tilting at an angle of about 45 degrees from a video display apparatus 1, and then, using a retroreflector 2 titling at an angle of about 45 degrees from the second light-transmittable plate 100 or the reflection-type light polarizer 101. A surface of the retroreflector 2 is provided with a λ/4 plate 21, and the video light is converted into the other polarized wave by a waveplate during entering of the video light into and reflection of it on the retroreflector 2, and then, the video light is transmitted through the reflection-type light polarizer 101 and an absorption-type light polarizer 102 in the second light-transmittable plate 100, and forms the air floating image in a space partitioned by the second light-transmittable plate 100.

The retroreflector 2 has a structure in which polyhedral reflection surfaces are arrayed as illustrated in FIG. 1(B), and the video light is reflected on a polyhedron 2a (hexahedron in the drawing) twice to become the retroreflected light and form the air the air floating image. In this case, resolution of floating image is generally defined by a pitch of the polyhedron 2a in the retroreflector 2 per unit area. An air image 220 formed by the video light reflected on the retroreflector 2 is formed in the space partitioned by the second light-transmittable plate 100, and a distance between the retroreflector 2 and the air image 220 is the same as an optical distance between the video display apparatus 1 and the retroreflector 2. In this case, if a diffusion angle of the video light is large, abnormal light is formed in addition to the video light normally reflected on the polyhedron on the reflection surface of the retroreflector 2, and therefore, ghost images g1 and g2 (only two ghost images are illustrated in FIG. 1 although formed depending on the number of the reflection surfaces) are formed around the normal air image 220. In order to reduce these ghost images, a diffusion angle of a light source 13 in the video display apparatus 1 is preferably a narrow diffusion angle as described later.

### <Exemplary Configuration of First Retroreflector Optical System or Retroreflector Optical Unit for Forming Air Floating Video Information Display System>

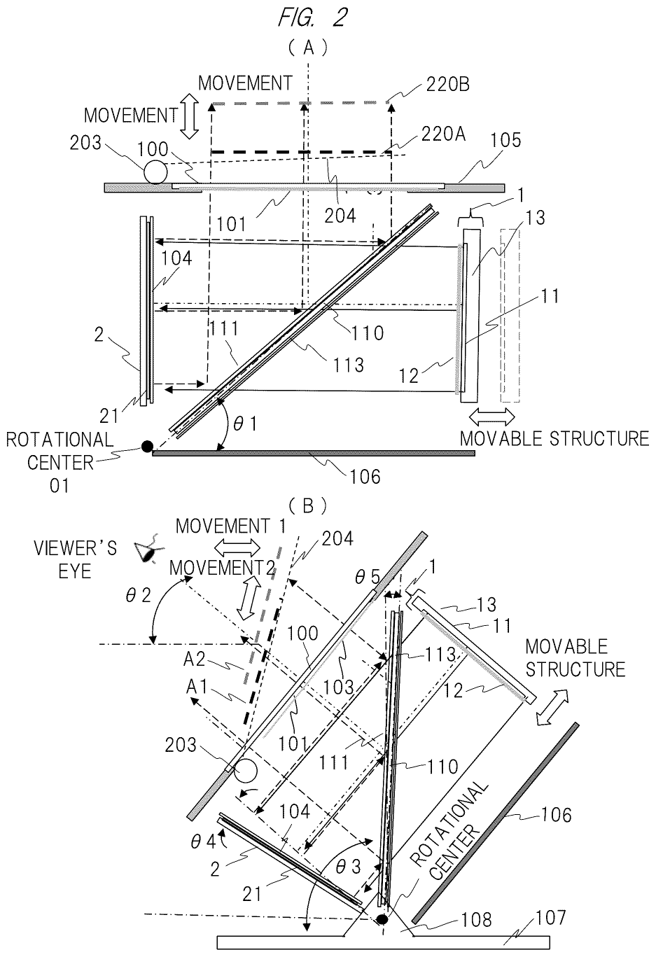

FIG. 2(A) is a diagram illustrating an exemplary aspect of the retroreflector optical system (also referred to as “unit” below) used to achieve the air floating video information display system of the present disclosure. FIG. 2(B) is a diagram for explaining an entire configuration of the air floating video information display system of the present embodiment. The air floating video information display system or air floating video information n display apparatus including the light source apparatus 13, a display panel 11, the retroreflector 2 and a first light-transmittable plate 110 is housed in a housing, and a part of the housing is provided with a member to be connected to the air floating video information display system or air floating video information display apparatus.

With reference to FIG. 2(A), according to, for example, the air floating video information display system (also referred to as “present system” below) of the present disclosure, if the air floating video information display system is placed on a desk for a viewer of the air floating video, the viewer looks down the air floating video. In FIG. 2(A), the video display apparatus 1 and the retroreflector 2 are arranged in substantially parallel or parallel to each other. Specifically, a video display surface or video-light emission surface of the display panel 11 configuring the video display apparatus 1 is arranged to exactly face a reflection surface of the retroreflector 2. In this case, the image forming position (illustrated as 220A, 220B in FIG. 2(A)) of the air floating image moves upward and downward in response to an amount of movements of the video display apparatus 1 in right and left directions in the drawing to be along the second light-transmittable plate 100. As illustrated in FIG. 2(A), the movements of the video display apparatus 1 in the right and left direction described here are movement in a direction of getting close to the retroreflector 2 and movement in a direction of getting away from the retroreflector 2. In other words, even in the same aspect system, the image forming position of the air floating image can be optionally changed by change in the position of the video display apparatus 1.

Functions of the optical member configuring the retroreflector optical system will be explained below. The video display apparatus 1 is made of the light source apparatus 13 having the narrow-angle diffuse property and the liquid crystal display panel 11. As a result, in the air information display system of the present invention, the video light of the specific polarized wave having the narrow-angle diffuse property is formed, and propagates to the first light-transmittable plate 110. Although one side surface of the first light-transmittable plate 110 is provided with a reflection-type light polarizer sheet 111 functioning as a light-polarization beam splitter, the light of the specific polarized wave emitted from the video display apparatus 1 is transmitted. In this case, a light entering surface of the first light-transmittable plate 110 may be provided with an anti-reflection film or a sheet 113, a surface of which has a moth-eye structure having a property of a reflectance not changed by an incident angle and a wavelength of the light.

The video light transmitted through the first light-transmittable plate 110 is retro-reflected by the retroreflector 2. The first light-transmittable plate 110 tilts by “θ1” (about 45 degrees) from an optical axis connecting the video display apparatus 1 and the retroreflector 2. If this tilt angle θ1 is larger than 45 degrees, the image forming position of the air floating image 220A illustrated in FIG. 2(A) can be moved leftward in the drawing. Similarly, the image forming position of the air floating image 220A illustrated in FIG. 2(A) can be moved rightward in the drawing. As described above, in the unit configuration of the present invention, the image forming position of the air floating image can be adjusted to the desirable position by the change in the arrangement of the optical member configuring the unit, and therefore, the basic configuration of the unit can be made common, and the efficiency of the mass production can be increased.

The retroreflector 2 forms the retroreflected light, and besides, converts the video light of the specific polarized wave into the other polarized wave while using the λ/4 plate provided on its surface, and therefore, the video light is reflected on the reflection-type light polarizer sheet 111 on the one side surface of the first light-transmittable plate 110, is transmitted through the second light-transmittable plate 100 and the reflection-type light polarizer sheet 101 on the upper surface, and forms the air floating image 220A. An interface of the λ/4 plate 21 on the surface of the retroreflector 2, the interface being close to air, may be provided with an anti-reflection film or a sheet 104, a surface of which has a moth-eye structure having a property of a reflectance not changed by an incident angle and a wavelength of the light.

When a position of the placement of the video display apparatus 1 is moved in the right or left direction in the drawing to be at an optional position, the image forming position of the air floating image 220A can be set to, for example, the position 220B. As illustrated in FIG. 2(A), the video display apparatus 1 and the retroreflector 2 are arranged in substantially parallel or parallel to each other. In this case, it is desired to increase a floating amount (that is a distance from the first light-transmittable plate 110) of the air floating image, it is only necessary to increase the distance between the video display apparatus 1 and the retroreflector 2, and it is only necessary to move the video display apparatus 1 rightward and set it in the embodiment illustrated in FIG. 2(A). The floating amount described here is a distance between the first light-transmittable plate 110 and the air floating video.

The air floating video information display system or air floating video information display apparatus of the present embodiment may be structured to move the video display apparatus 1 or the display panel 11. Specifically, the video display apparatus 1 is fixed to the housing through an elastic member. The air floating video information display system or air floating video information display apparatus may be structured to adjust the arrangement angle of the first light-transmittable plate 110. Specifically, the first light-transmittable plate 110 is fixed to the housing through an elastic member.

Therefore, the image forming position of the air floating image changes depending on a distance between the video display apparatus 1 (or the display panel 11) and the first light-transmittable plate 110. That is, if the arrangement angle of the first light-transmittable plate 110 is constant, the image forming position of the air floating image is a position defined by the distance between the video display apparatus 1 or the display panel 11 and the first light-transmittable plate 110. Alternatively, the image forming position of the air floating image changes depending on the arrangement angle of the first light-transmittable plate 110. That is, if the distance between the video display apparatus 1 and the first light-transmittable plate 110 is constant, the image forming position of the air floating image is a position defined by the arrangement angle of the first light-transmittable plate 110.

In this unit, a distance between an optional point of the video display apparatus 1 or the display panel 11 and a corresponding point of the first light-transmittable plate 110 and a distance between an optional point of the air floating image 220A and a corresponding point of the first light-transmittable plate 110 are equal to each other at all positions of the air floating image 220A in the right and left directions, and therefore, a focus degree of the formed air image is equal in the full screen region, and the favorable air floating video can be formed. Specifically, a distance between an optional point of the video-light emission surface of the display panel 11 and a corresponding point of the first light-transmittable plate 110 and a distance between an optional point of the air floating image 220A and a corresponding point of the first light-transmittable plate 110 are equal to each other at all positions of the air floating image 220A in the right and left directions.

Further, the external light entering from the outside of the housing into the unit after passing through the second light-transmittable plate 100 that is an opening propagates to be substantially perpendicular (vertical) to the first light-transmittable plate 110, and does not directly enter the surface of the retroreflector 2 and the video display apparatus 1 away from the opening. Further, the light of the polarized wave of the external light entering the housing, the light being the same as the video light of the specific polarized wave emitted from the video display apparatus 1, does not affect the image quality of the air floating image because of being transmitted through the reflection-type light polarizer sheet 111 functioning as the light-polarization beam splitter on the one side surface of the first light-transmittable plate 110, and being absorbed by a light absorber 106.

Further, in order to use this air floating image as a key input apparatus by interaction caused by the viewer's touch with the air floating image, a sensing system 203 described later is arranged at an end of the air floating image to make a sensing region larger than the air floating image, and, as a result, the favorable performance can be provided.

### <Exemplary Configuration of Air Floating Video Information Display System>

FIG. 2(B) is a diagram illustrating a configuration of the air floating video information display system of the present disclosure. The functions of the optical member configuring the unit illustrated in FIG. 2(A) have been described above, and therefore, will not be described here. The air floating video information display system or air floating video information display apparatus including the light source apparatus 13, the display panel 11, the retroreflector 2 and the first light-transmittable plate 110 is housed in the housing, and a part of the housing is provided with the member to be connected to the air floating video information display system or air floating video information display apparatus.

Specifically, this unit is fixed to a rotational structure 108 and a main body 107 for supporting this unit. For example, according to this system of the present disclosure with reference to an air floating image 204 (A1 and A2 are illustrated as the image forming positions), if this system is arranged to face the viewer of the air floating video, the viewer obliquely looks down the air floating video. In this case, in order to optimally arrange the image forming position of the air floating image 204 in a front or back direction of this system, the image forming position is moved forward or backward (in the right or left direction in the drawing)) in response to the amount of the rightward or leftward movement of the position of the video display apparatus 1 of the unit illustrated in the drawing. That is, even in the system of the same aspect, the image forming position of the air floating image can be optionally optimized as client's needed by the change in the position of the video display apparatus 1.

As similar to FIG. 2(A), the retroreflector 2 forms the retroreflected light, and besides, converts the video light of the specific polarized wave into the other polarized wave while using the λ/4 plate provided on its surface, and therefore, the video light is reflected on the reflection-type light polarizer sheet 111 on the one side of surface the first light-transmittable plate 110, is transmitted through the second light-transmittable plate 100 on the upper surface, and forms the air floating image 220A. The interface of the λ/4 plate 21 on the surface of the retroreflector 2, the interface being close to air, may be provided with an anti-reflection film or a sheet 113, a surface of which has a moth-eye structure having a property of a reflectance not changed by an incident angle and a wavelength of the light.

When the position of the placement of the video display apparatus 1 is moved and set in the up or down direction in the drawing, the image forming position of the air floating image 204 can be optionally set to, for example, a position in the front or back direction of the viewer. In this case, if it is desired to increase the floating amount (the distance from the second light-transmittable plate 100) of the air floating video, it is only necessary to increase the distance between the video display apparatus 1 and the retroreflector 2, and it is only necessary to move the video display apparatus 1 upward in the embodiment illustrated in FIG. 2(B). As illustrated in FIG. 2(B), the movements of the placement position of the video display apparatus 1 in the up and down direction described here are movement of the video display apparatus 1 in an up or down direction to be along the second light-transmittable plate 100 or movement of the video display apparatus 1 in an up or down direction of the second light-transmittable plate 100.

Even in this unit, a distance between a center point of the video display apparatus 1 or the display panel 11 and a corresponding point of the first light-transmittable plate 110 and a distance between a center point of the air floating image 204 and a corresponding point of the first light-transmittable plate 110 are equal to each other at all positions of the air floating image in the up and down directions, and therefore, a focus degree of the formed air image is equal in the full screen region, and the favorable air floating video can be formed. The center point of the video display apparatus 1 or the display panel 11 described here is a center point of the video-light emission surface of the video display apparatus 1 or the display panel 11.

Further, the external light entering from the outside of the housing into the unit after passing through the second light-transmittable plate 100 that is an opening propagates to be substantially perpendicular to the second light-transmittable plate 100, and does not directly enter the surface of the retroreflector 2 and the video display apparatus 1 away from the opening, and therefore, does not affect the image quality of the air floating image.

Further, in order to use this air floating image as a key input apparatus by interaction caused by the viewer's touch with the air floating image, the sensing system 203 described later is arranged inside the housing to achieve a sensing system with the less influence from the use environment. In this case, the near infrared rays used for the sensing do not affect the sensing performance because of being transmitted through the second light-transmittable plate 100 and the reflection-type light polarizer sheet 101. Further, by making a sensing region of this sensing system larger than the air floating image 204, the favorable performance can be provided.

### <Exemplary Air Floating Video Information Display System>

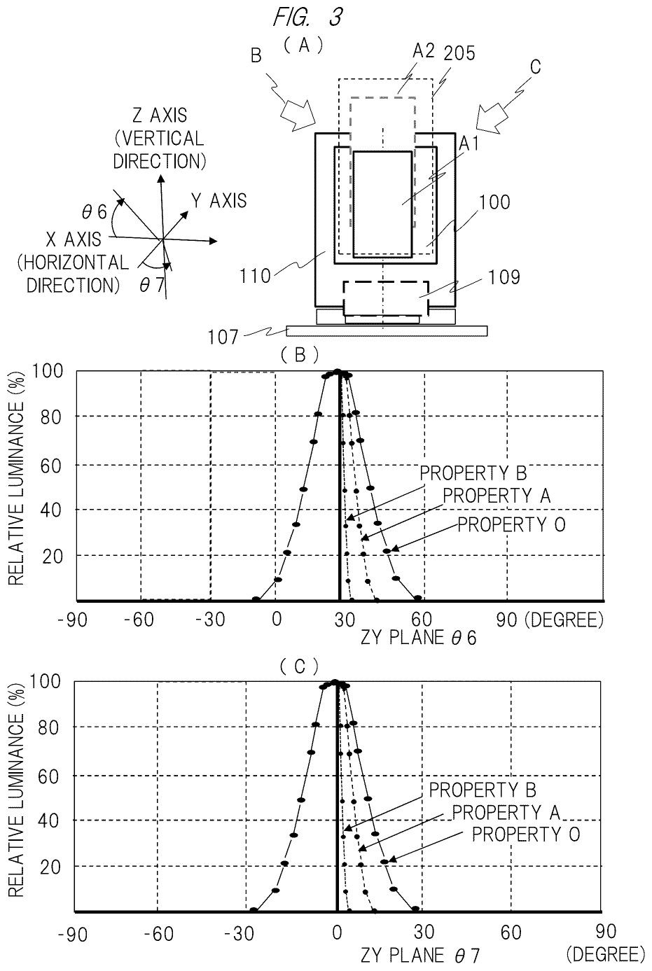

FIG. 3(A) is a diagram illustrating the appearance of the air floating video information display system of the present disclosure. The system includes the unit illustrated in FIG. 2(B), and this unit is fixed to the main body 107 for supporting the unit and the rotational structure 108 (not illustrated), and, as a result, an air floating video A1 is formed at a desirable position. The image forming position of the air floating video can be changed by change in a setting angle θ3 of the unit inside the system. For example, if a reference setting position is assumed to be “A1”, in order to set the forming position of the air floating video to an upper position “A2”, the angle θ3 of the entire unit is made larger than the reference angle. Alternatively, an attachment angle θ4 of the retroreflector 2 may be set to an angle to open from the video display apparatus 1. Further, the same effect is provided by further tilting a setting angle θ5 of the second light-transmittable plate 100 including the reflection-type light polarizer sheet 101 from the opening of the housing. In this case, the sensing region 205 of the sensing system may be determined to entirely include the air floating image, the forming position of which is changed by the arrangement of the optical member configuring the unit.

### <Technique of Controlling Diffuse Property of Video Display Apparatus>

In the embodiment of the present invention, as the diffuse distribution of the video light emitted from the liquid crystal display panel 11 that is the video source of the video display apparatus 1, the diffuse property of the light source apparatus 13 is adjusted by a shape and surface roughness of a surface of a light guiding body. Further, the light emission direction of the video light is controlled by optimization of a shape of a lenticular lens provided between the retroreflector 2 and the liquid crystal display panel 11 or provided on the surface of the liquid crystal display panel 11. In other words, by the optimization of the shape of the lenticular lens, the light emission property of the video light (also referred to as “video luminous flux” below) unidirectionally emitted from the liquid crystal display panel 11 can be adjusted.

A micro lens array in a matrix form may be alternatively or additionally arranged on the surface of the liquid crystal display panel 11 (or between the light source apparatus 13 and the liquid crystal display panel 11) to adjust an aspect of the arrangement. In other words, by the adjustment the arrangement of the micro lens array, the light emission property of the video luminous flux emitted from the video display apparatus 1 in the X-axis direction and the Y-axis direction can be adjusted, and, as a result, a video display apparatus having the desirable diffuse property can be provided.

As another configuration example, combination of two lenticular lenses may be arranged or a sheet in which the micro lens array in the matrix form is arranged for adjusting the diffuse property may be arranged at a position at which the video light emitted from the image display apparatus 1 passes. By such an optical system configuration, a luminance (relative luminance) of the video light in the X-axis direction and the Y-axis direction can be adjusted in accordance with the reflection angle of the video light (the reflection angle provided when the reflection in the vertical direction is set to a criterion (0 degree)).

Because of use of such a lenticular lens, the present embodiment can provide the diffuse property that is different among the planes as shown with the graph (plot curve) of “Example 1 (Z-Y direction)” in FIG. 3(B) and “Example 2 (Z-X direction)” in FIG. 3(C). Specifically, as illustrated in the graph of “Example 1 (Z-Y direction)” in FIG. 3(B) and “Example 2 (Z-X direction)” in FIG. 3(C), the diffuse property can be individually controlled by setting a viewing angle property of the air floating video information display apparatus in the horizontal direction to be a property “O” on a Z-X plane while setting the diffuse property in the vertical direction to be a property “A” illustrated in FIG. 3(B). This results in an optimal viewing angle property for the application of the air floating video information display apparatus, and besides, results in the air floating image with the higher luminance than that of a video display apparatus using a light source apparatus having a related-art diffuse property.

### <Second Exemplary Configuration of Air Floating Video Information Display System>

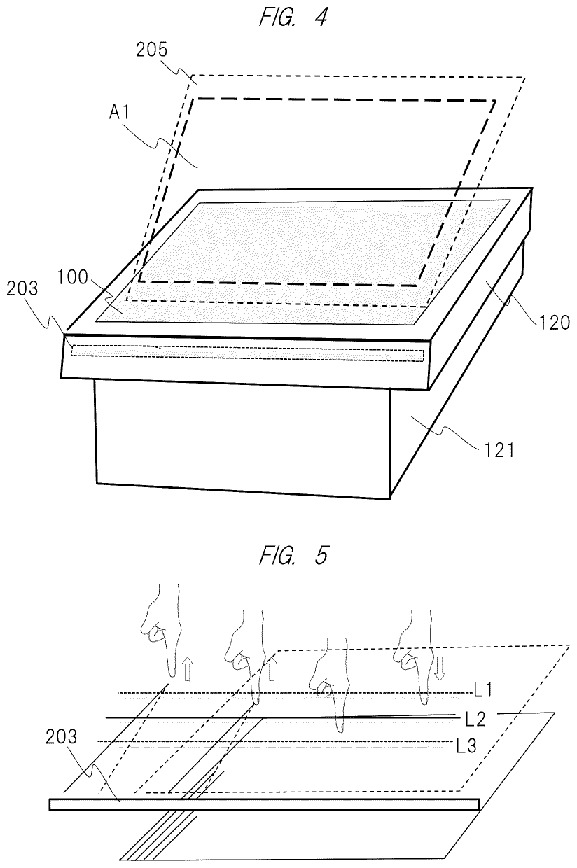

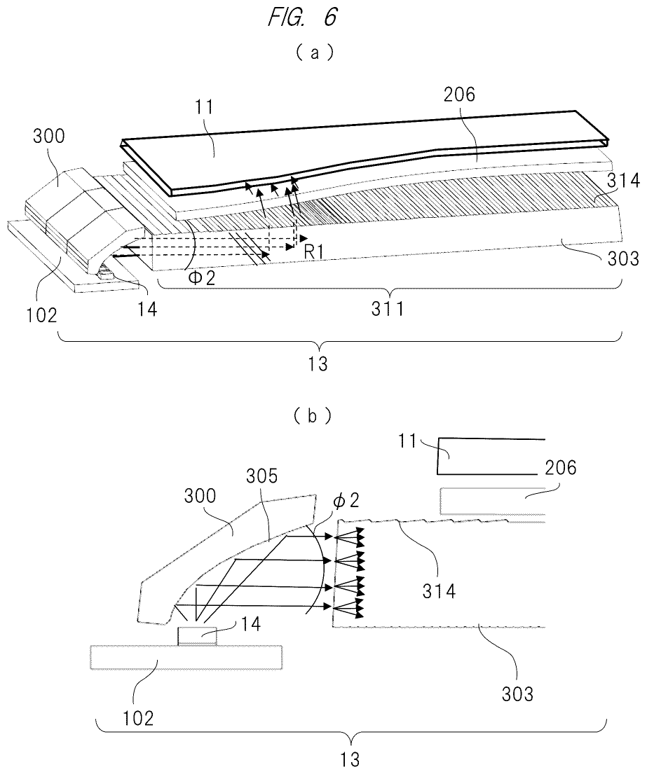

A second embodiment of the air floating video information display system will be described with reference to FIG. 4. In FIG. 4, the unit illustrated in FIG. 2(B) is arranged inside a housing 121. Since the sensing unit (not illustrated) is arranged inside the second light-transmittable plate 100 and the reflection-type light polarizer sheet 101, the sensing region 205 is secured to have the enough size to the air floating video A1. The sensing unit 203 illustrated in FIG. 5 is arranged inside the housing 121, and a part of the second light-transmittable plate 100 and the reflection-type light polarizer sheet 101, the part being closer to the housing, is provided with an O ring or the like to prevent intrusion of moisture from the outside. The sensing unit 203 for sensing the sensing area (sensing region) 205 covering the image forming area A1 of the air floating video information display apparatus is arranged inside the housing 121, and the light is transmitted through the second light-transmittable plate 100 and the reflection-type light polarizer sheet 101 to form the sensing area.

Even by the above-described second embodiment of the air floating video information display system, the user can perform the aerial operation input to the displayed image forming video A1. Further, as a result of evaluation on the finger touch with a trial product using a practical apparatus, when the image forming position of the image forming video A1 is away by 50 mm or more from the first light-transmittable plate 110, the operator can perform the aerial operation input to the air floating video information display system without the touching with the screen.

As similar to the above description, the configuration described 4 may be included in various display apparatuses such as ATM, automatic ticket dispenser, kiosk terminal, and stationary display apparatus.

### <Technique Means for Sensing Air Video>

A sensing technique for virtually operating the air floating video such that the viewer (operator) is bidirectionally connected to the information system through the air floating video information display apparatus will be described below.

In the air floating video information display system, the sensing information is read together with the air floating video by a two-dimensional sensor described later to achieve the image operation to the displayed video.

The sensing technique for virtually operating the air floating video such that the viewer (operator) is bidirectionally connected to the information system through the air floating video information display apparatus will be described below. FIG. 5 is a principle diagram for explaining the sensing technique. A ranging apparatus 203 including a time of flight (TOF) system corresponding to the air floating video is provided. A near-infrared light emitting diode (LED) that is a light source is caused to emit light in synchronization with a signal of the system. A light emission side of the LED is provided with an optical element for adjusting the divergence angle, and a pair of high-sensitivity avalanche diodes having picosecond-order time resolution as light receiving elements are aligned in the horizontal direction so as to correspond to the area.

A phase shift Δt is caused to correspond to time taken from the light emission of the LED that is the light source in synchronization with the signal of the system through the reflection of the light by the object (here, the tip of the viewer's finger) to be measured in distance till the return of the reflection light to the light receiver. A distance to the object is calculated from this time difference Δt, and a position and motion of the operator's finger are sensed as the two-dimensional information in combination of the distance and information of positions of a plurality of parallel-arranged sensors. This results in an air floating video information display system or an air floating video information display apparatus having a sensing function with less erroneous sensing for the air floating video.

### <Technique of Reducing Ghost Image>

When a WUXGA liquid crystal display panel of 7 inches (1920×1200 pixels) is used as the liquid crystal display panel 11 used in the video display apparatus 1, even if one pixel (one triplet) is about 80 μm, if a pitch B is, for example, 420 μm as a light-transmittable portion d2 of a made of 400 μm retroreflection portion while 20 μm as a light-absorbing portion d1 of the same, this achieves the sufficient light-transmittable property and controls the diffuse property of the video light emitted from the video display apparatus, the diffuse property being the cause of the occurrence of the abnormal light on the retroreflector, and therefore, the ghost image formed on both sides of the air floating image can be reduced.

The surface of the liquid crystal panel 11 is provided with a video light control sheet. This video light control sheet also prevents intrusion of external light emitted from the outside into the air floating video display apparatus, and prevents entering of the light into the liquid crystal panel 11, and therefore, leads to improvement of reliability of the components. For the video light control sheet, for example, a viewing-angle control film (VCF) manufactured by Shin-Etsu Polymer Co., Ltd., is suitable. A structure of the VCF has a sandwich structure in which transparent silicon and black silicon are alternately arranged while the light entering/emitting surface is provided with a synthetic resin. Therefore, the external light can be controlled.

### <Performance of Liquid Crystal Panel>

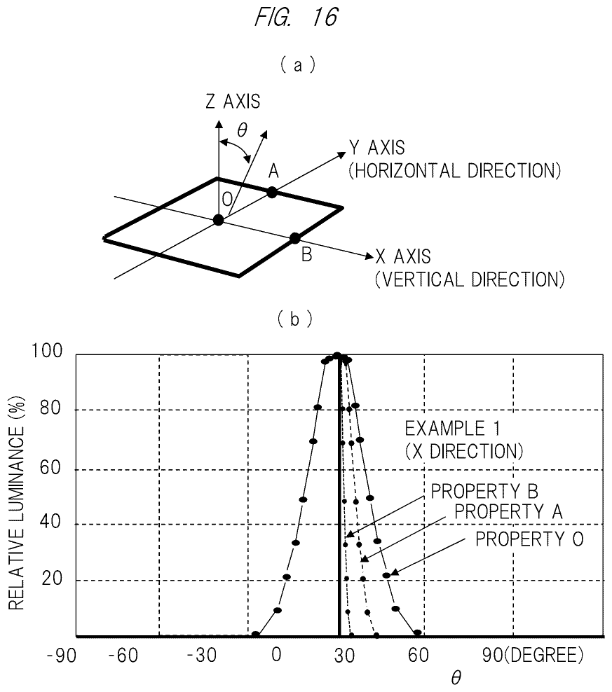

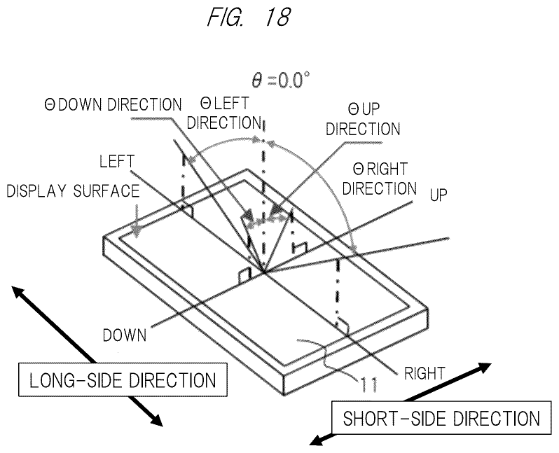

Incidentally, a general thin film transistor (TFT) liquid crystal panel has the luminance and the contrast performance depending light emission direction because of the properties of both liquid crystals and the polarizer. In the evaluation under measurement environment illustrated in FIG. 18, the luminance and the viewing-angle properties in the panel short-side (up and down) direction are excellent at an angle shifting slightly (by +5 degrees in this embodiment) from the emission angle perpendicular to the panel surface (the emission angle of 0 degree) as illustrated in FIG. 20. This is because the light twist property in the short-side (up and down) direction of the liquid crystal panel is not 0 degree at the maximum applied voltage.

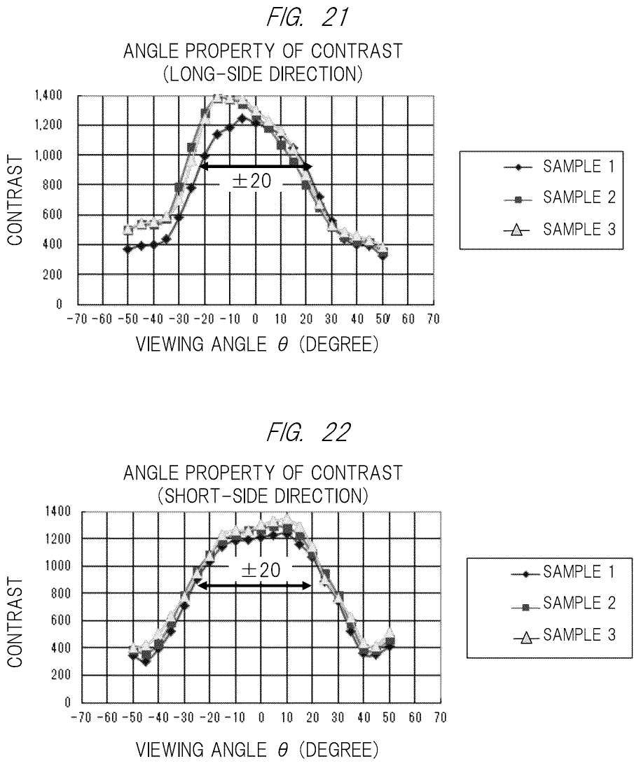

On the other hand, the contrast performance in the panel short-side (up and down) direction is excellent in a range of −15 degrees to +15 degrees as illustrated in FIG. 22, and therefore, its most excellent property along with the luminance property is provided under the use in a range of ±10 degrees around 5 degrees.

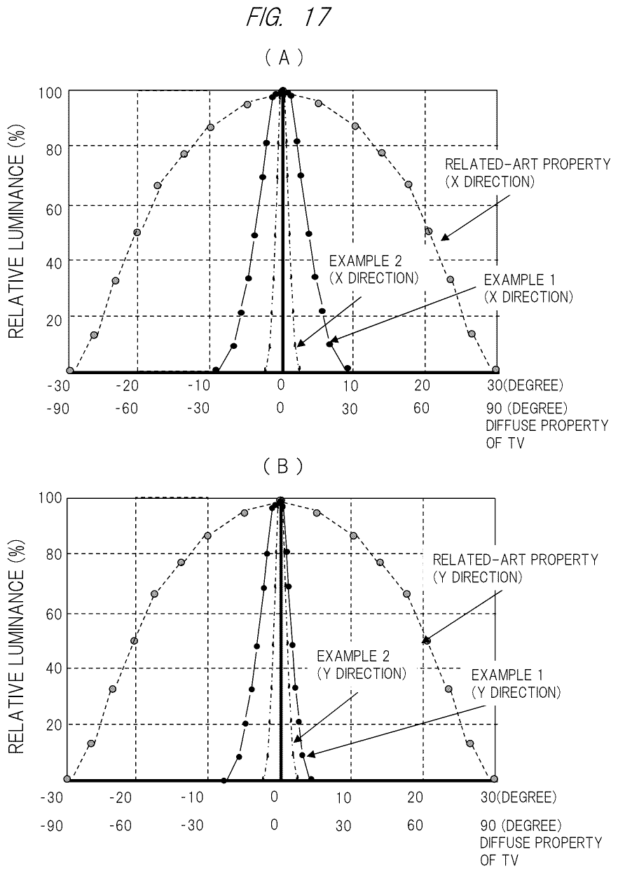

Further, the luminance and the viewing-angle properties in the panel long-side (right and left) direction are excellent at the emission angle perpendicular to the panel surface (the emission angle of 0 degree) as illustrated in FIG. 19. This is because the light twist property in the long-side (right and left) direction of the liquid crystal panel is 0 degree at the maximum applied voltage.

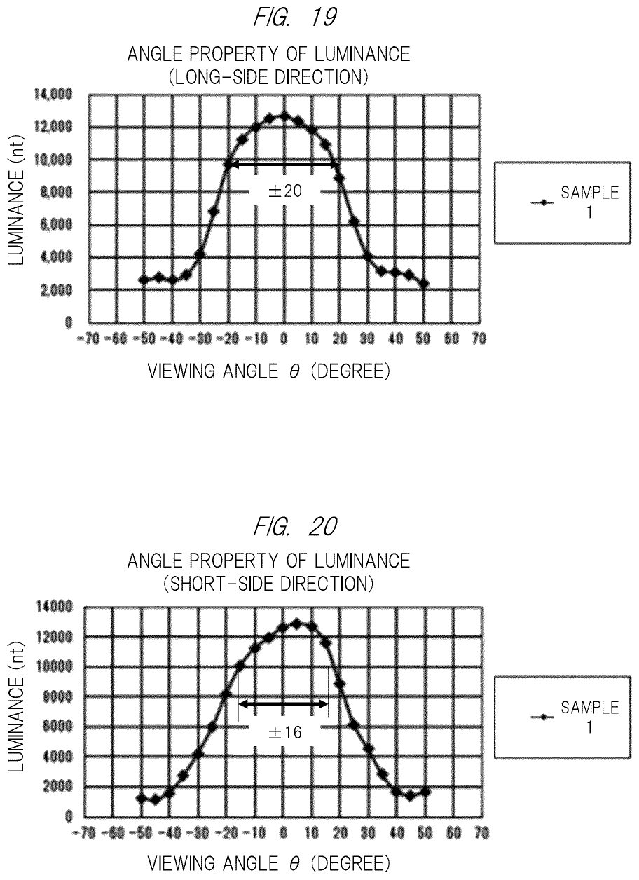

Similarly, the contrast performance in the panel long-side (horizontal) direction is excellent in a range of −5 degrees to −10 degrees as illustrated in FIG. 21, and its most excellent property along with the luminance property is provided under the use in a range of #5 degrees around-5 degrees. Thus, as the emission angle of the video light emitted from the liquid crystal panel, the light is made incident on the liquid crystal panel in a direction in which the most excellent property is provided by a light-flux direction converter (such as reflection surfaces 307 and 314) provided on the light guiding body of the light source apparatus 13, and is optically modulated by a video signal to improve the image quality and the performance of the video display apparatus 1.

When the incident light emitted from the light source into the liquid crystal panel is set in the above range in order to maximize the luminance and the contrast properties of the liquid crystal panel serving as the video display element, the video quality of the air floating video can be improved.

### <Method of Controlling Light-Source Light>

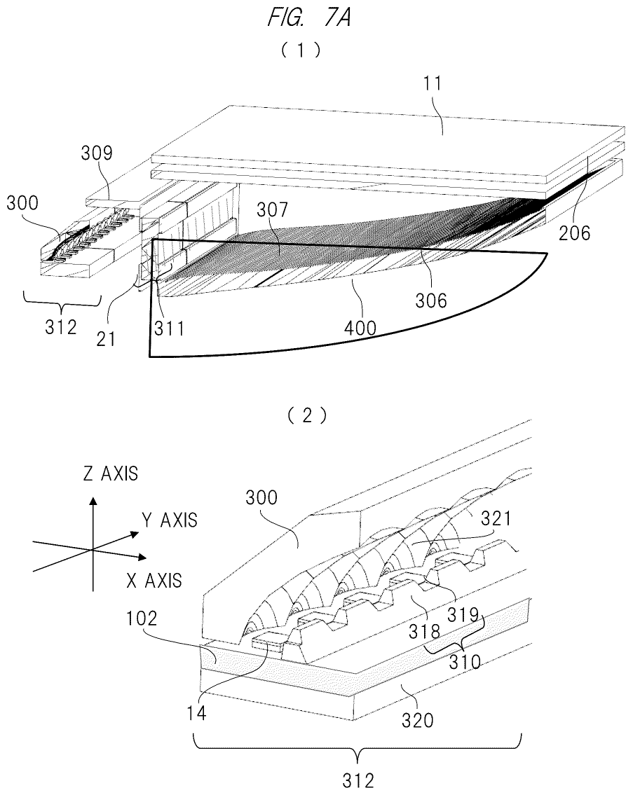

In the present embodiment, as illustrated in FIG. 6, in order to improve the use efficiency of the emission light flux emitted from the light source apparatus 13 to remarkably reduce the power consumption, the video light ray emitted from the light source apparatus 13 of the video display apparatus 1 including the light source apparatus 13 and the liquid crystal display panel 11 is made incident on the liquid crystal panel 11 at the incidence angle maximizing the property of the liquid crystal panel 11, and then, is modulated in terms of the luminance in accordance with the video signal, and is emitted toward the retroreflector. At this time, in order to downsize a volume of the air floating video information display system set, it is desirable to increase a degree of freedom of arrangement of the liquid crystal panel 11 and the retroreflector. Further, the following technique is used for forming the floating video at a desired position after the retroreflection to secure the optimum directionality.

In the video display surface of the liquid crystal panel 11, a transparent sheet made of the optical component such as the linear Fresnel lens is provided on a front surface of the light-direction converter panel, and therefore, the emission direction of the incident light flux toward the retroreflector optical member is controlled with high directionality to determine the image forming position of the air floating video. In this configuration, the video light emitted from the video display apparatus 1 efficiently reaches the viewer while having the high directionality (rectilinear propagation) as similar to laser beam. As a result, the high-quality floating video can be displayed at high resolution, and the power consumption based on the video display apparatus 1 including the light source apparatus 13 can be remarkably reduced.

### <First Exemplary Video Display Apparatus>

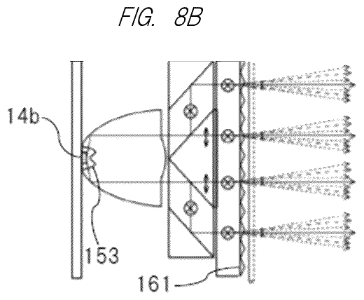

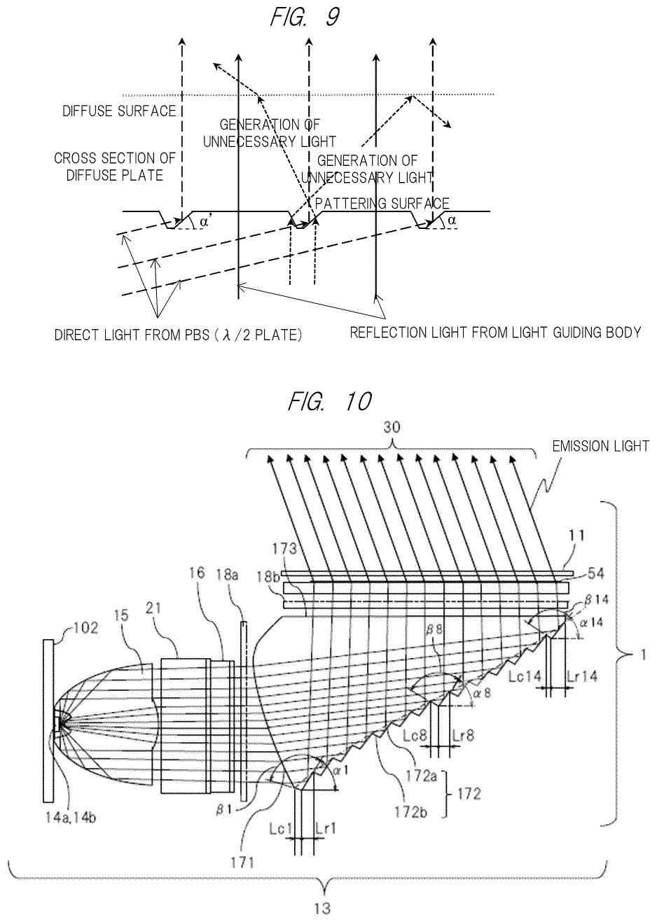

FIG. 11 shows another exemplary specific configuration of the video display apparatus 1. The light source apparatus of FIG. 11 has the similar configuration to that of a light source apparatus of FIG. 12 or the like. This light source apparatus 13 is configured such that an LED, a collimator, a synthesis (composite)/diffuse block, a light guiding body and the like are housed in a case made of plastic or the like. The liquid crystal display panel 11 is attached onto an upper surface of the light source apparatus 13. An LED substrate on which light emitting diode (LEDs) elements 14a and 14b that are semiconductor light sources and a control circuit for the LED elements are mounted is attached to one side surface of the case of the light source apparatus 13 while a heat sink (not illustrated) that is a member for cooling the heat generated in the LED elements and the control circuit is attached to an outer surface of the LED substrate.

To a liquid crystal display panel frame attached to an upper surface of the case, the liquid crystal display panel 11 attached to this frame, a flexible wiring substrate (Flexible Printed Circuit: FPC) (not illustrated) electrically connected to this liquid crystal display panel 11 and others are attached. In other words, the liquid crystal display panel 11 that is the liquid crystal display element generates the display video in corporation with the LED elements 14a and 14b that are solid light sources by modulating an intensity of the transmission light on the basis of a control signal output from a control circuit (not illustrated here) configuring the electronic device.

### <First Exemplary Light Source Apparatus in First Exemplary Video Display Apparatus>

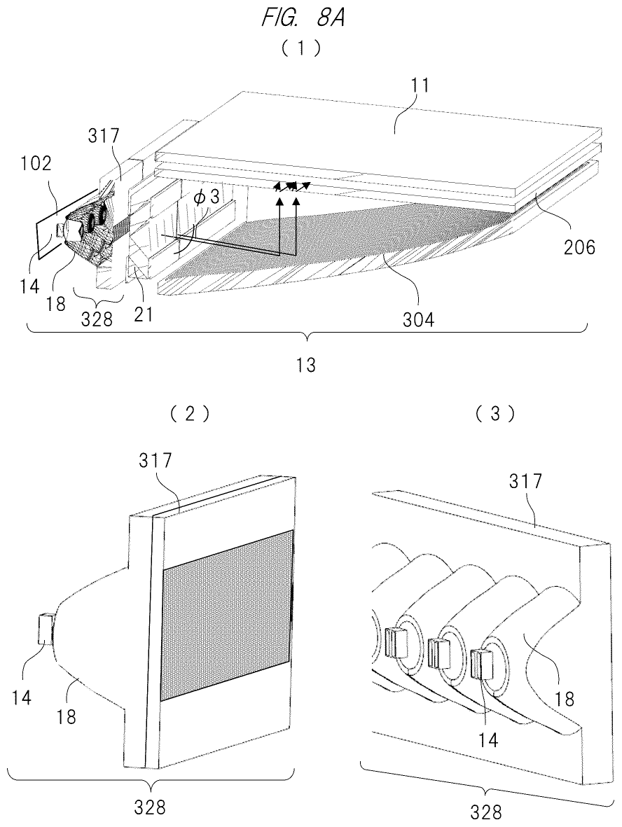

Subsequently, a configuration of the optical system such as the light source apparatus housed in the case will be explained in detail with reference to FIGS. 12(a) and 12(b) in addition to FIG. 10. FIGS. 10 and 11 illustrate the LEDs 14a and 14b configuring the light source, and these LEDs are attached to a predetermined position to correspond to the collimators 15. Note that each of the collimators 15 is made of, for example, a light-transmittable resin such as acrylic resin. As illustrated in FIG. 11(b), the collimator 15 has a conically convex outer circumferential surface 156 formed by rotation of a paraboloid cross section, and has a concave portion 153 with a convex portion (in other words, a convex lens surface) 157 at center of its apex (a side in contact with the LED substrate).

A center of a plane portion (on an opposite side of the apex) of the collimator 15 has a convex lens surface 154 that protrudes outward (or may be a concave lens surface that is recessed inward). Note that the paraboloid surface 156 forming the conically-shaped outer circumferential surface of the collimator 15 is set at an angle range allowing the light peripherally emitted from the LED elements 14a and 14b to be internally totally reflected, or forming the reflection surface.

Each of the LED elements 14a and 14b is arranged at a predetermined position on the surface of the substrate 102 that is circuit substrate. The substrate 102 is arranged and fixed so that each LED element 14a or 14b on its surface is positioned at center of the concave portion 153 to correspond to the LED collimator 15.

In such a configuration, by the collimator 15, among the light emitted from the LED element 14a or 14b, particularly the light emitted upward (in the right direction in the drawing) from its center is collected to form the collimated light by two convex lens surfaces 157 and 154 forming the outer shape of the collimator 15. The light peripherally emitted from other portions is reflected by the paraboloid surface forming the conically-shaped outer circumferential surface of the collimator 15, and is similarly collected to form the collimated light. In other words, by the collimator 15 having the convex lens formed on its center and the paraboloid surface formed on the peripheral portion, almost all the light components generated by the LED element 14a or 14b can be extracted as the collimated light, and the use efficiency of the generated light can be improved.

Note that a light emission region of the collimator 15 is provided with a polarization converter element 21. The polarization converter element 21 may be also referred to as polarization converter member. As clearly seen from FIG. 11(a), the polarization converter element 21 is made of combination of a pillar-shaped light transmittable member having a parallelogram cross section (referred to as parallelogram pillar below) and a pillar-shaped light transmittable member having a triangle cross section (referred to as triangle pillar below), and a plurality of these members are arranged in an array form in parallel to a surface perpendicular to an optical axis of the collimated light emitted from the collimator 15. Further, a light-polarization beam splitter (abbreviated below as PBS film) 211 and a reflection film 212 are alternately arranged at a boundary between the adjacent light transmittable members that are arranged in the array form. The emission surface from which the light having entered the polarization converter element 21 and been transmitted through the PBS film 211 is emitted includes a λ/2 plate 213.

The emission surface of the polarization converter element 21 is further provided with the rectangular synthesis/diffuse block 16 as shown in FIG. 11(a). In other words, the light emitted from the LED 14a or 14b is formed as the collimated light by the function of the collimator 15, enters the synthesis/diffuse block 16, and is diffused by a texture 161 on the emission side, and then, reaches the light guiding body 17.

The light guiding body 17 is a member made of a light transmittable resin such as acrylic resin and is shaped in a bar having a substantially triangle cross section (see FIG. 11(b)). As also illustrated in FIG. 11, the light guiding body 17 has a light-guiding-body light entrance portion (surface) 171 facing an emission surface of the synthesis/diffuse block 16 to interpose a first diffuse plate 18a therebetween, a light-guiding-body light reflection portion (surface) 172 forming an inclined surface, and a light-guiding-body light emission portion (surface) 173 facing the liquid crystal display panel 11 that is a liquid crystal display element to interpose a second diffuse plate 18b therebetween.

As shown in FIG. 10 that is a partial enlarged diagram of the light-guiding-body light reflection portion 172, a lot of reflection surfaces 172a and joint surfaces 172b are alternately formed in a serration form on the light-guiding-body light reflection portion (surface) 172 of the light guiding body 17. And, an angle “αn” (n: a natural number of, for example, 1 to 130 in the present example) is formed by the reflection surface 172a (a right upward line component in the drawing) and a horizontal surface illustrated with a dashed dotted line in the drawing. As its one example, the angle “αn” is set to be equal to or smaller than 43 degrees (but equal to or larger than 0 degree) here.

The light-guiding-body light entrance portion (surface) 171 is formed to have a curved convex shape being oblique toward the light source. In this manner, the collimated light emitted from the light emission surface of the synthesis/diffuse block 16 is diffused and enters through the first diffuse plate 18a, reaches the light-guiding-body light reflection portion (surface) 172 while slightly bending (being polarized) upward by the light-guiding-body light entrance portion (surface) 171 as clearly seen from FIG. 10, and is reflected by this light reflection portion, and reaches the liquid crystal display panel 11 arranged on the light emission surface on the upper side of the drawing sheet.

According to the video display apparatus 1 descried above, the light use efficiency and the equalized illumination property can be more improved, and the apparatus including the modularized light source apparatus for the S-polarized wave can be manufactured at a low cost to be downsized. In the above-described explanation, note that the polarization converter element 21 is attached at a subsequent stage of the collimator 15. However, the present invention is not limited to this arrangement, and the same function and effect can be provided even by arrangement of the polarization converter element 21 in middle of a light path extending to the liquid crystal display panel 11.

Note that a lot of reflection surfaces 172a and joint surfaces 172b are alternately formed in the serration form on the light-guiding-body light reflection portion (surface) 172. The illumination light flux is totally reflected on each reflection surface 172a, and propagates upward, and besides, enters a light-direction converter panel 54 for controlling the directionality as substantially collimated diffuse light flux by a narrow-angle diffuse plate arranged on the light-guiding-body light emission portion (surface) 173, and enters the liquid crystal display panel 11 in an oblique direction. The emission direction of the emission light of the video display apparatus 1 is adjusted by the light-direction converter panel 54 arranged on the upper surface of the light source apparatus 13. As a result, the emission light emitted from the liquid crystal display panel 11 is also controlled, and the light diffuse direction of the resultant air floating video of the air floating video information system using the video display apparatus 1 is controlled. In the present embodiment, the light-direction converter panel 54 is arranged between the light-guiding-body emission surface 173 and the liquid crystal display panel 11. However, arrangement of the light-direction converter panel 54 on the emission surface of the liquid crystal display panel 11 can also provide the same effect.

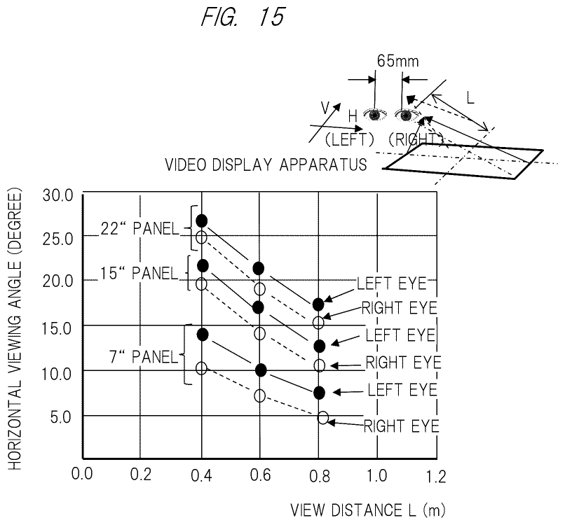

In a general apparatus for TV, the emission light emitted from the liquid crystal display panel 11 has the same diffuse property between a screen horizontal direction (display direction corresponding to an X axis in a graph of FIG. 17(A)) and a screen vertical direction (display direction corresponding to a Y axis in a graph of FIG. 17(B)) as illustrated in, for example, plot curves of “related-art property (X direction)” in FIG. 17(A) and “related-art property (Y direction) in FIG. 17(B).

On the other hand, the diffuse property of the light flux emitted from the liquid crystal display panel according to the present embodiment is as illustrated in, for example, plot curves of “Example 1 (X direction)” in FIG. 17(A) and “Example 1 (Y direction)” in FIG. 17(B).

In a specific example, if a viewing angle having a luminance that is 50% of a luminance (luminance reduced to be half) of front view (angle of 0 degree) is set to 13 degrees, this angle is about ⅕ of the diffuse property (62 angle degrees) of the apparatus for general household-use TV. Similarly, for example, if a viewing angle in the vertical (perpendicular) direction is set to unequal between the upper side and the lower side, a reflection angle of the reflection-type light guiding body, an area of the reflection surface and others are optimized so that the upper viewing angle is reduced (narrowed) to be about ⅓ of the lower viewing angle.

Since the viewing angles and the like are set as described above, an amount of the video light toward a user's viewing direction is remarkably made larger (is remarkably more improved in terms of brightness of the video) than that of the related-art liquid crystal TV, and the luminance of the video is more than 50 times.

Further, in a case of the viewing-angle property of the “Example 2” of FIG. 17, if a viewing angle having a luminance that is 50% of a luminance (luminance reduced to be half) of front view (angle of 0 degree) is set to 5 degrees, this angle is an angle of about 1/12 (narrow viewing angle) of the diffuse property (62 angle degrees) of the apparatus for general household-use TV. Similarly, for example, if a viewing angle in the vertical direction is set to unequal between the upper side and the lower side, a reflection angle of the reflection-type light guiding body, an area of the reflection surface and others are optimized so that the viewing angle in the vertical direction is reduced (narrowed) to be about 1/12 of the related-art viewing angle.

By such setting as described above, luminance (amount) of the video light toward the viewing direction (user's viewing direction) is remarkably made larger (is remarkably more improved in terms of brightness of the video) than that of the related-art liquid crystal TV, and the luminance of the video is more than 100 times.

As described above, since the viewing angle is the narrower viewing angle, the light flux toward the viewing direction can be concentrated to remarkably improve the light use efficiency. As a result, even if the general liquid crystal display panel for TV is used, when the light diffuse property of the light source apparatus is adjusted, the luminance can be remarkably improved at equivalent power consumption to achieve the video display apparatus for the information display system for bright outdoors.

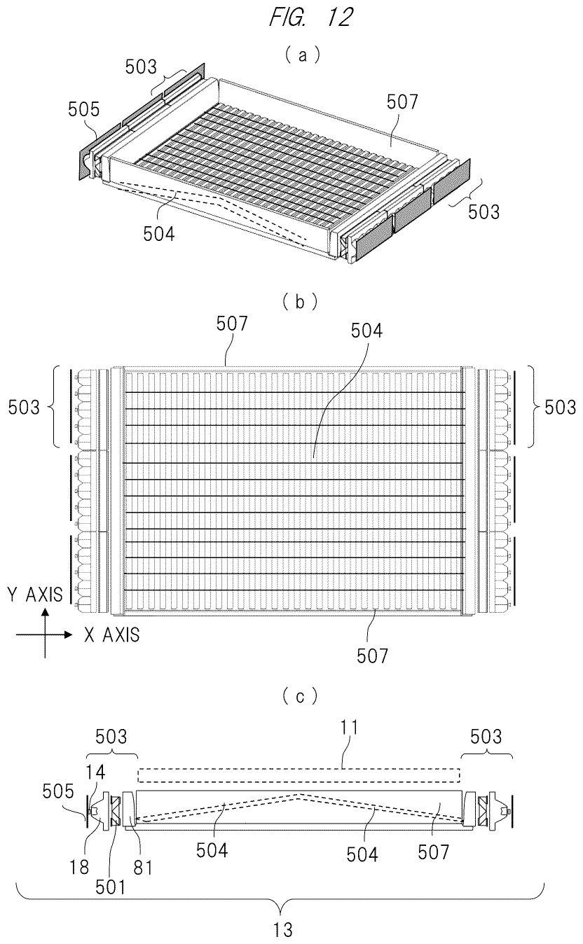

In use of a large liquid crystal display panel, when the light on the periphery of the screen is directed inward to propagate toward the viewer when the viewer faces the center of the screen, a full-screen performance in terms of the screen brightness is improved. In FIG. 14, a convergence angle made by a long side of the liquid crystal display panel and a short side of the liquid crystal display panel is found by using a distance “L” from the liquid crystal display panel to the viewer and a panel size (screen ratio (16:10)) of the video display apparatus as parameters. An upper drawing is in assumption that the video is viewed so that the screen of the liquid crystal display panel is portrait-oriented (also referred to as “vertically-long use” below). In this case, the convergence angle may be set to match with the short side of the liquid crystal display panel (see a direction of an arrow “V” in FIG. 14 as necessary).

In more specific example, with reference to the plot graph in FIG. 14, for example, if a view distance under the vertically-long use of the 22″ panel is 0.8 m, when the convergent angle is set to 10 degrees, the video light emitted from each of (four) corners of the screen can be effectively projected or output to the viewer.

Similarly, if the view distance under the vertically-long use of the 15″ panel is 0.8 m, when the convergent angle is set to 7 degrees, the video light emitted from the four corners of the screen can be effectively caused to propagate toward the viewer. As described above, depending on the size of the liquid crystal display panel or whether the use is the vertically-long use or the horizontally-long use, the video light on the periphery of the screen is caused to propagate toward the viewer at the optimal position for viewing the center of the screen, and, as a result, the full-screen performance in terms of the screen brightness can be improved.

In a basic configuration, when the light flux having the narrow-angle directionality is made incident on the liquid crystal display panel 11 by the light source apparatus as shown in FIG. 17 described above and others and is modulated in terms of the luminance in accordance with the video signal, the video information displayed on the screen of the liquid crystal display panel 11 is reflected by the retroreflector, and the resultant air floating video is displayed inside or outside the room through the transparent member 100.

A plurality of examples will be explained below as another example of the light source apparatus. All such another examples of the light source apparatus may be applicable in place of the light source apparatus of the above-described example of the image display apparatus.

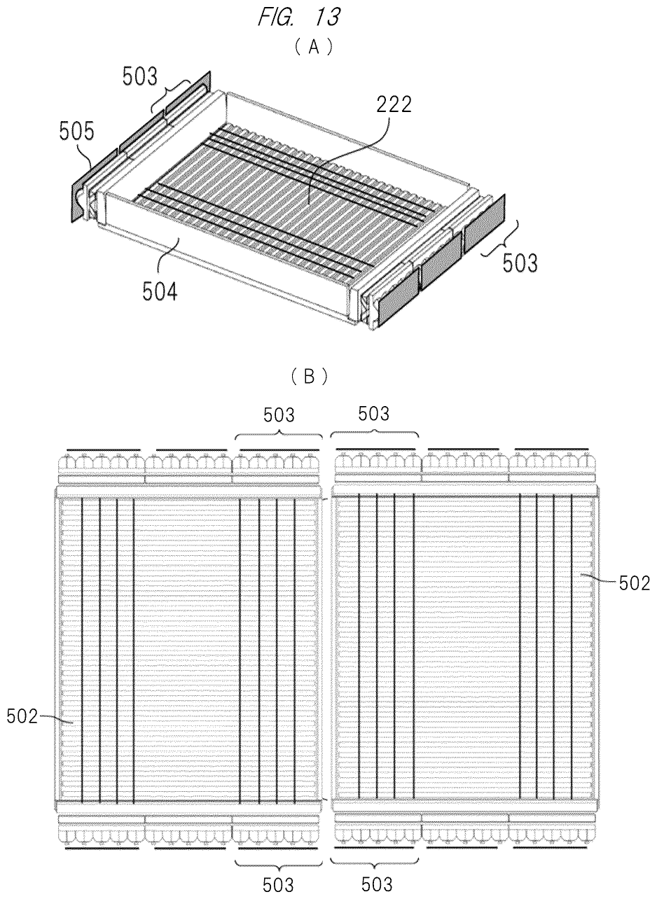

As described above, in use of the large liquid crystal display panel, when the light on the periphery of the screen is directed inward to propagate toward the viewer when the viewer faces the center of the screen, the full-screen performance in terms of the screen brightness is improved. On the other hand, binocular disparity is caused depending on viewing by either right or left eye of the viewer. In FIG. 15, a convergent angle made by a long side of the liquid crystal display panel and a short side of the liquid crystal display panel is found with respect to positions of the right and left eyes by using a distance “L” from the liquid crystal display panel to the viewer and a panel size (screen ratio 16:10) of the video display apparatus as parameters.

The smaller the panel size is, or, the smaller (closer) the viewing distance is, the larger the convergent angle in the binocular disparity using both right and left eye is. Particularly in use of a small panel of 7 inches or smaller, the convergent angle in the binocular disparity is an important factor. Therefore, in the case of, for example, 7 inches or smaller, the video light is designed to be directed in an optimum viewing range of the system by increase in the light diffuse property or the directionality of the light source of FIG. 17.

Further, depending on a required specification of the system, it is necessary to optimally design the shape, the surface roughness, the tilt, and the like of the reflection surface of the light guiding body of the light source apparatus 13 in order to achieve the horizontal and vertical directionality and the diffuse property.

### <First Exemplary Light Source Apparatus>

Next, with reference to FIG. 6, another exemplary light source apparatus will be explained. Each of FIGS. 6(a) and 6(b) is a diagram in which a part of the diffuse plate 206 and the liquid crystal display panel 11 is eliminated for explaining the light guiding body 311.

FIG. 6 shows a state of the substrate 102 provided with the LED 14 configuring the light source. The LED 14 and the substrate 102 are attached at predetermined positions to correspond to a reflector 300.

As shown in FIG. 6(a), the LEDs 14 are arranged on a line in parallel to the side (in this example, the short side) of the liquid crystal display panel 11 to be close to the arrangement of the reflector 300. In the illustrated example, the reflector 300 is arranged to correspond to the arrangement of the LED. Note that a plurality of the reflectors 300 may be arranged.

In a specific example, each reflector 300 is made of a plastic material. As another example, the reflector 300 may be made of a metal material or a glass material. However, since the plastic material is easier to be shaped, the plastic material is used in the present example.

As shown in FIG. 6(b), an inner (in the drawing, right) surface of the reflector 300 has a reflection surface (referred to as “paraboloid surface” below) 305 having a shape resulted from cut of a paraboloid surface at a meridional plane. In the reflector 300, the diffuse light emitted from the LED 14 is converted to the substantially collimated light by being reflected by the reflection surface 305 (paraboloid surface), and the converted light is caused to enter an end surface of the light guiding body 311. In a specific example, the light guiding body 311 is a transmission-type light guiding body.

The reflection surface of the reflector 300 has a shape that is asymmetric across an optical axis of the light emitted from the LED 14. Since the reflection surface 305 of the reflector 300 is the paraboloid surface as described above, the reflected light flux is converted to the substantially collimated light when the LED is arranged at a focal point of this paraboloid surface.

The diffuse light emitted from the LED cannot be converted to the completely collimated light even when the LED 14 is arranged at the focal point of this paraboloid surface because the LED 14 is the surface-emitting light source. However, a performance of the light source of the present invention is not affected. The LED 14 and the reflector 300 are paired. The number of the attachment of the LEDs to the substrate should be equal to or smaller than 10 in order to secure a predetermined performance when accuracy of the attachment of the LEDs 14 to the substrate 102 is ±40 μm, and is better to be about 5 in consideration of mass productivity.

Although the LED 14 and the reflector 300 are partially close to each other, rise of a temperature of the LED can be reduced since the heat can be released to a space near an opening of the reflector 300. Therefore, the plastic-molded reflector 300 is applicable. As a result, according to this reflector 300, the shaping accuracy of the reflection surface can be improved to be equal to or higher than 10 times of that of the glass reflector, and therefore, the light use efficiency can be improved.

Meanwhile, a base surface 303 of the light guiding body 311 is provided with a reflection surface, and the light emitted from the LED 14 is converted to the collimated light by the reflector 300, and then, is reflected by this reflection surface, and is emitted toward the liquid crystal display panel 11 facing the light guiding body 311. The reflection surface formed on the base surface 303 may have a plurality of surfaces that are different in a tilt from one another in the propagation direction of the collimated light flux emitted from the reflector 300 as shown in FIG. 6(a). Each surface of the plurality of surfaces that are different in the tilt from one another may have a shape extending in a direction perpendicular to the propagation direction of the collimated light flux emitted from the reflector 300.

A shape of the reflection surface formed on the base surface 303 may be a flat shape. In this case, by a refraction surface 314 formed on a surface of the light guiding body 311 facing the liquid crystal display panel 11, the light having been reflected on the reflection surface formed on the base surface 303 of the light guiding body 311 is refracted, and the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values.

The refraction surface 314 may include a plurality of surfaces that are different in a tilt from one another in the propagation direction of the collimated light flux emitted from the reflector 300 as shown in FIGS. 6(a) and 6(b). Each surface of the plurality of surfaces that are different in the tilt from one another may have a shape extending in a direction perpendicular to the propagation direction of the collimated light flux emitted from the reflector 300. By the tilt of each of the plurality of surfaces, the light having been reflected by the reflection surface formed on the base surface 303 of the light guiding body 311 is refracted toward the liquid crystal display panel 11. Alternatively, the refraction surface 314 may be a transmittable surface.

If the diffuse plate 206 is placed in front of the liquid crystal display panel 11, note that the light having been reflected by the reflection surface is refracted toward the diffuse plate 206 by the plurality of tilts of the refraction surface 314. In other words, an extending direction of each of the plurality of surfaces different from one another in the tilt on the refraction surface 314 and an extending direction of each of the plurality of surfaces different in the tilt from one another on the reflection surface formed on the base surface 303 are parallel. Since the both extending directions are made parallel, the angle of the light can be more preferably adjusted. Meanwhile, the LED 14 is soldered on a metallic substrate 102. Therefore, the heat generated in the LED can be released to air through the substrate.

The reflector 300 may be in contact with the substrate 102 or be spaced from it. When the space is formed, the reflector 300 is arranged to be tightly close to the housing. By the formed space, the heat generated in the LED can be released to air, and the cooling effect is enhanced. As a result, an operation temperature of the LED can be lowered, and therefore, retention of the light emission efficiency and the long life can be achieved.

### <Second Another Exemplary Light Source Apparatus>

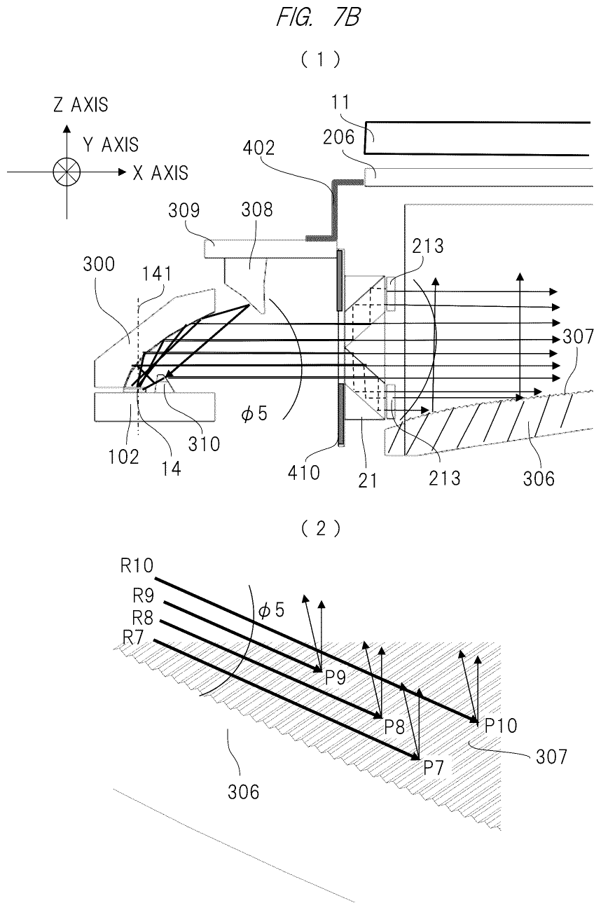

Subsequently, a configuration of an optical system regarding a light source apparatus having a light use efficiency under the usage of the light-polarization conversion that is 1.8 times better than a light use efficiency of the light source apparatus shown in FIG. 6 will be explained in detail with reference to FIGS. 7A, 7B, 7C and 7D. In FIG. 7A, note that illustration of a sub reflector 308 is omitted.

FIGS. 7A, 7B and 7C illustrate the state of the substrate 102 provided with the LED 14 configuring the light source, and a unit 312 is configured to include a plurality of blocks each made of a pair of the reflector 300 and the LED 14.

Among these members, a base member 320 shown in FIG. 7A(2) is a base member of the substrate 102. Generally, the metallic substrate 102 has heat, and therefore, the base member 320 may be made of a plastic material or others in order to (thermally) insulate the heat of this substrate 102. A material of the reflector 300 and a shape of the reflection surface may be the same material and shape as those of the example of the light source apparatus of FIG. 6.

The reflection surface of the reflector 300 may have a shape that is asymmetric across the optical axis of the light emitted from the LED 14. A reason for this will be explained with reference to FIG. 7A(2). In the present example, the reflection surface of the reflector 300 is the paraboloid surface as similar to that of the example of FIG. 6, and the center of the light emission surface of the LED that is the surface-emitting light source is arranged at the focal position of the paraboloid surface.

And, because of the characteristics of the paraboloid surface, the light emitted from the four corners of the light emission surface also becomes the substantially collimated light flux, and is different in only the light emission direction. Therefore, even if the light emitting unit has an area, when a distance between the reflector 300 and the polarization converter element 21 arranged at the subsequent stage is small, the light quantity and the conversion efficiency of the light entering the polarization converter element 21 are hardly affected.

And, even if the attachment position of the LED 14 shifts on an X-Y plane from the focal point of the corresponding reflector 300, the optical system capable of suppressing the reduction of the light conversion efficiency can be achieved because of the above-described reason. Further, even if the attachment position of the LED 14 varies in a Z-axis direction, only movement of the converted collimated light flux on a Z-X plane is needed, the attachment precision requirement for the LED that is the surface-emitting light source can be significantly reduced. Also in the present example, the reflector 300 having the reflection surface resulted from cutting of a part of the paraboloid surface on a meridian has been explained. However, the LED may be arranged in a cut part of the entire paraboloid surface as the reflection surface.

On the other hand, as shown in FIGS. 7B(1) and 7C, the present example has a characteristic configuration in which the diffuse light emitted from the LED 14 is reflected and converted to the substantially collimated light by the paraboloid surface 321, and then, is caused to enter the end surface of the polarization converter element 21 at the subsequent stage, and is equalized to have the specific polarized wave by the polarization converter element 21. By such a characteristic configuration, the light use efficiency of the present invention is 1.8 times better than that of the example of FIG. 6, and the light source having high efficiency can be achieved.

In this case, note that all components of the substantially collimated light resulted from the reflection of the diffuse light emitted from the LED 14 by the paraboloid surface 321 are not equalized. Therefore, the angular distribution of the reflection light is adjusted by the reflection surface 307 having the plurality of tilts, and the light can be caused to enter the liquid crystal display panel 11 in the direction perpendicular to the liquid crystal display panel 11.

In the example of these drawings, the direction of the light (principal ray) entering the reflector from the LED and the direction of the light entering the liquid crystal display panel are arranged to be substantially parallel to each other. This arrangement is easily made in terms of the design, and arrangement of the thermal source below the light source apparatus is more preferable since the temperature increase of the LED can be decreased by the upward air release.

As shown in FIG. 7B(1), in order to improve a capture rate of the diffuse light emitted from the LED 14, the light flux incapable of being captured by the reflector 300 is reflected by the sub reflector 308 formed in a light shielding plate 309 above the reflector, is reflected by a tilt surface of a sub reflector 310 on a lower side, and is caused to enter an effective region of the polarization converter element 21 at the subsequent stage, and therefore, the light use efficiency is further improved. In other words, in the present example, a part of the light having been reflected by the reflector 300 is reflected by the sub reflector 308, and the light having been reflected by the sub reflector 308 is reflected toward the light guiding body 306 by the sub reflector 310.

By the reflection shape on the surface of the reflection-type light guiding body 306, the substantially collimated light flux having the specific polarized wave equalized by the polarization converter element 21 is reflected toward the liquid crystal display panel 11 facing the light guiding body 306. In this case, the light-quantity distribution of the light flux entering the liquid crystal display panel 11 is optimally designed by the shape and the arrangement of the reflector 300, and the reflection surface shape (cross-sectional shape), the reflection surface tilt and the surface roughness of the reflection-type light guiding body and others.

The plurality of reflection surfaces are arranged as the reflection surface shape formed on the surface of the light guiding body 306 to face the light emission surface of the polarization converter element 21 such that the tilt, the area, the height and the pitch of the reflection surface are optimized in accordance with the distance from the polarization converter element 21, and, as a result, the light-quantity distribution of the light flux entering the liquid crystal display panel 11 is designed to be a desirable value as described above.

The reflection light can be accurately adjusted when the reflection surface 307 formed on the reflection-type light guiding body is configured to have one surface with the plurality of tilts as shown in FIG. 7B(2). In such a configuration of the reflection surface having one surface with the plurality of tilts, note that a region to be used as the reflection surface may be made of a plurality of surfaces, a polygonal surface or a curved surface. Further, the light-quantity distribution can be more equalized by a diffuse function of the diffuse plate 206. The light-quantity distribution of the light entering the diffuse plate closer to the LED can be equalized by change of the tilt of the reflection surface. As a result, the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately adjusted. Therefore, in the air video information display system using the video display apparatus using this light source, the diffuse direction and the diffuse angle of the video light of the air floating video can be set to desirable values.

In the present example, a plastic material such as heat-resistant polycarbonate is used for the base member of the reflection surface 307. An angle of the reflection surface 307 to which the light propagates immediately after the light emission from the λ/2 plate 213 is changed in accordance with a distance between the λ/2 plate and the reflection surface.

Also in the present example, although the LED 14 and the reflector 300 are partially close to each other, the heat can be released to the space near the opening of the reflector 300, and the temperature increase of the LED can be decreased. Alternatively, up-and-down arrangement order of the substrate 102 and the reflector 300 may be inversed from the arrangement of FIGS. 7A, 7B and 7C.

However, if the substrate 102 is arranged on the upper side, the substrate 102 is close to the liquid crystal display panel 11, and therefore, layout may be made difficult. Therefore, the arrangement of the substrate 102 on the lower side of the reflector 300 (to be farther from the liquid crystal display panel 11) as shown in the drawing makes the configuration in the apparatus simpler.

As shown in FIG. 7C, the light entering surface of the polarization converter element 21 may be provided with a light shielding plate 410 in order to prevent the unnecessary light from entering the optical system at the subsequent stage. By such a configuration, the light source apparatus in which the temperature increase is suppressed can be achieved. The light polarizer on the light entering surface of the liquid crystal display panel 11 can absorb the light flux having the equalized light polarization as described in the present invention to decrease the temperature increase, and the light polarizer on the entering side can absorb a part of the light having the light polarization direction rotated when being reflected by the reflection-type light guiding body. The temperature of the liquid crystal display panel 11 is also increased by the temperature increase due to the absorbance in the liquid crystals themselves and the light entering the electrode pattern. However, since there is the sufficient space between the liquid crystal display panel 11 and the reflection surface of the reflection-type light guiding body 306, the liquid crystal display panel 11 can be naturally cooled.

FIG. 7D shows a modification example of the light source apparatus of FIGS. 7B(1) and 7C. FIG. 7D(1) shows a modification example of a part of the light source apparatus of FIGS. 7B(1). Configurations of other components are the same as those of the light source apparatus of FIG. 7B(1), and therefore, illustration and repetitive explanation of the same will be omitted.

First, in the example shown in FIG. 7D(1), a height of a concave portion 319 of the sub reflector 310 is adjusted to be lower than a phosphor (fluorescent body) 114 so that fluorescence principal ray (see a straight line extending in a direction parallel to the X-axis in FIG. 7D(1)) emitted in the horizontal direction (X-axis direction) from the phosphor 114 is released out of the concave portion 319 of the sub reflector 310. Further, a height of a light shielding plate 410 in the Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

The reflection surface of the convex portion of convex and concave on the apex of the sub reflector 310 reflects the light having been reflected by the sub reflector 308 in order to guide the light having been reflected by the sub reflector 308 toward the light guiding body 306. Therefore, a height of a convex portion 318 of the sub reflector 310 is adjusted so that the light having been reflected by the sub reflector 308 is reflected and is caused to enter the effective region of the polarization converter element 21 at the subsequent stage, and, as a result, the light use efficiency can be further improved.

Note that the sub reflector 310 is arranged to extend in one direction as shown in FIG. 7A(2), and has the convex and concave shape. On the apex of the sub reflector 310, convex and concave having one or more concave portions are periodically arranged in one direction. Such a convex and concave shape achieves the configuration in which the fluorescence principal ray emitted in the horizontal direction from the phosphor 114 enters the effective region of the polarization converter element 21.

The convex and concave shape of the sub reflector 310 is periodically arranged at a pitch at which the concave portion 319 is positioned at the LED 14. In other words, each phosphor 114 is periodically arranged in one direction to correspond to the pitch of the arrangement of the concave portion of the convex and concave of the sub reflector 310. If the LED 14 includes the phosphor 114, note that the phosphor 114 may be interpreted as the light emitter portion of the light source.

FIG. 7D(2) shows a modification example of a part of the light source apparatus of FIG. 7C. Configurations of other components are the same as those of the light source apparatus of FIG. 7C, and therefore, illustration and repetitive explanation of the same will be omitted. As shown in FIG. 7D(2), the sub reflector 310 may be eliminated. However, as similar to FIG. 7D(1), the height of the light shielding plate 410 in the Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

In the light source apparatuses of FIGS. 7A, 7B, 7C and 7D, note that a sidewall 400 may be formed as shown in FIG. 7A (1) in order to prevent dusts from entering the space between the liquid crystal display panel 11 and the reflection surface of the reflection-type light guiding body 306, prevent stray light toward outside of the light source apparatus and prevent stray light from entering from the outside of the light source apparatus. When the sidewall 400 is formed, the sidewall 400 is arranged to sandwich a space between the light guiding body 306 and the diffuse plate 206.

The light emission surface of the polarization converter element 21 that emits the light having been converted in terms of the light polarization by this polarization converter element 21 faces a space surrounded by the sidewall 400, the light guiding body 306, the diffuse plate 206 and the polarization converter element 21. A reflection surface having a reflection film or others is used as a surface of inner surfaces of the sidewall 400, the surface covering, from a side surface, a space in which the light is emitted from the light emission surface of the polarization converter element 21 (the space is a right space of the light emission surface of the polarization converter element 21 of FIG. 7B(1)). In other words, the surface of the sidewall 400 facing this space has the reflection region having the reflection film. Since this portion of the inner surfaces of the sidewall 400 is used as the reflection surface, the light having been reflected by this reflection surface can be reused as the light of the light source, and the luminance of the light source apparatus can be improved.

The surface of the inner surfaces of the sidewall 400, the surface covering the polarization converter element 21 from the side surface, is formed as a surface having a low light reflectance (such as a black surface without the reflection film or others). This is because the reflection light on the side surface of the polarization converter element 21 generates the light having the unexpected light polarization state to be a cause of the stray light. In other words, when the surface is formed as the surface having the low light reflectance, the generation of the stray light of the video and the light having the unexpected light polarization state can be prevented or suppressed. Alternatively, a part of the sidewall 400 may be configured to have an air-flow hole to improve the cooling effect.

Note that the configuration using the polarization converter element 21 is a prerequisite on the explanation for the light source apparatuses of FIGS. 7A, 7B, 7C and 7D. However, a configuration in which the polarization converter element 21 is eliminated d from such a light source apparatus is also applicable. In this case, such a light source apparatus can be provided at a less cost.

### <Third Another Exemplary Light Source Apparatus>

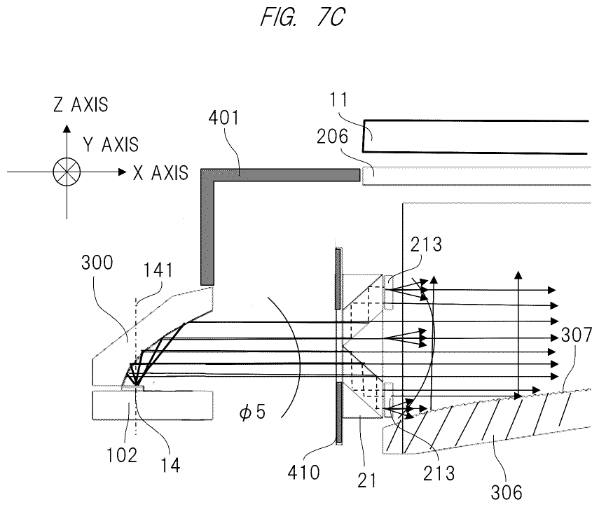

Subsequently, a configuration of an optical system regarding a light source apparatus using the reflection-type light guiding body 304 based on the light source apparatus shown as the first exemplary light source apparatus will be explained in detail with reference to FIGS. 8A(1), (2) and (3) and 8B.

FIG. 8A shows a state of the substrate 102 provided with the LED 14 configuring the light source, and a unit 328 is configured to include a plurality of blocks each made of a pair of the collimator 18 and the LED 14. Since the collimator 18 of the present example is close to the LED 14, the glass material is used in consideration of the thermal resistance. A shape of the collimator 18 is the same as the shape explained in the collimator 15 in FIG. 7. And, the light shielding plate 317 is arranged at a previous stage of the entering to the polarization converter element 21, and, as a result, the unnecessary light is prevented or suppressed from entering the optical system at a subsequent stage, and the temperature increase due to the unnecessary light is decreased.

Since other configurations and effects of the light source shown in FIG. 8A are the same as those of FIGS. 7A, 7B, 7C and 7D, the repetitive explanation thereof will be omitted. In the light source shown in FIG. 8A, a sidewall may be formed as similar to those explained in FIGS. 7A, 7B and 7C. A configuration and an effect of the sidewall has been already explained, and therefore, the repetitive explanation thereof will be omitted.

FIG. 8B is a cross-sectional view of FIG. 8A (2). A configuration of a light source shown in FIG. 8B is partially in common with the configuration of the light source shown in FIG. 7, and has been already explained in FIG. 7, and therefore, the repetitive explanation thereof will be omitted.

### <Fourth Another Exemplary Light Source Apparatus>

Subsequently, the light source apparatus of FIG. 12 is made of the unit 328 including the plurality of blocks each made of the pair of the collimator 18 and the LED 14 used in the light source apparatus shown in FIG. 8. A configuration of an optical system regarding a light source apparatus using a reflection-type light guiding body 504 and an LED arranged on both ends of a back surface of the liquid crystal display panel 11 will be explained in detail with reference to FIGS. 12(a), (b) and (c).

FIG. 12 shows a state of a substrate 505 provided with the LED 14 configuring the light source, and a unit 503 is configured to include a plurality of blocks each made of a pair of the collimator 18 and the LED 14. The unit 503 is arranged on both ends of the back surface of the liquid crystal display panel 11 (in the present example, three units are arranged to align in the short-side direction). The light emitted from the unit 503 is reflected by the facing reflection-type light guiding body 504, and is caused to enter the liquid crystal display panel 11 (illustrated in FIG. 12(c)).

As shown in FIG. 12(c), the reflection-type light guiding body 504 is divided into two blocks corresponding to the units arranged on the respective ends, and has a center portion formed to be the highest. Since the collimator 18 is close to the LED 14, the glass material is used in consideration of the thermal resistance against the heat generated in the LED 14. A shape of the collimator 18 is a shape as explained in the collimator 15 in FIG. 10.

The light emitted from the LED 14 enters a polarization converter element 501 through the collimator 18. The distribution of light entering the reflection-type light guiding body 504 at the subsequent stage is configured to be adjusted by a shape of an optical element 81. In other words, the light-quantity distribution of the light flux entering the liquid crystal display panel 11 is optimally designed by adjusting the shape and arrangement of the collimator 18, the shape and the diffuse property of the optical element 81, the shape (cross-sectional shape) of the reflection surface of the reflection-type light guiding body, the tilt of the reflection surface and the surface roughness of the reflection surface.

As the shape of the reflection surface formed on the surface of the reflection-type light guiding body 504, a plurality of reflection surfaces are arranged to face the light emission surface of the polarization converter element as shown in FIG. 12(b), and the tilt, the area, the height and the pitch of the reflection surface are optimized in accordance with a distance from the polarization converter element 21. Also, a region to be the same reflection surface (the region is a surface facing the polarization converter element) is divided to form a polyhedron, and, as a result, the light-quantity distribution of the light flux entering the liquid crystal display panel 11 can be set (optimized) to have a desirable value as described above. As a result, the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately adjusted. Therefore, in the air video information display system using the video display apparatus using this light source, the diffuse direction and the diffuse angle of the video light of the air floating video can be set to desirable values.

As similar to the reflection-type light guiding body explained in FIG. 7B, one surface (that is a light reflecting region) of the reflection surface formed on the reflection-type light guiding body is configured to have the shape with the plurality of tilts (in the example of FIG. 12, with 14-divided surfaces with different tilts on the X-Y plane), and, as a result, the reflection light can be more accurately adjusted. And, a light shielding wall 507 is arranged in order to prevent the reflection light emitted from the reflection-type light guiding body from leaking through a side surface of the light source apparatus 13, and, as a result, occurrence of leak light that does not propagate in the desirable direction (that is the direction toward the liquid crystal display panel 11) can be prevented.

The unit 503 arranged on right and left of the reflection-type light guiding body 504 of FIG. 12 may be replaced with the light source apparatus of FIG. 7. In other words, a plurality of the light source apparatuses (the substrate 102, the reflector 300, the LED 14 and others) of FIG. 7 may be prepared, and the plurality of the light source apparatuses may be arranged at positions facing one another with reference to FIGS. 12(a), (b) and (c).

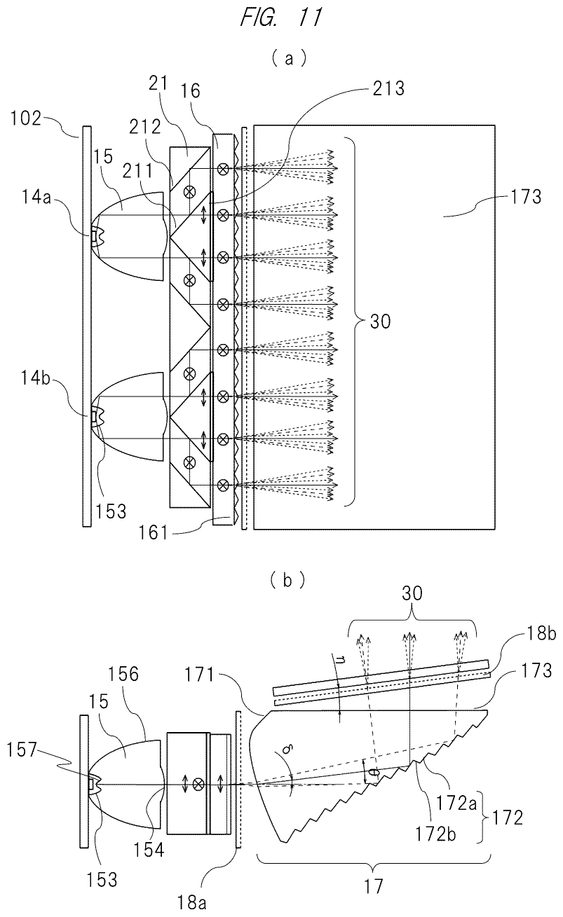

FIG. 13(B) shows a light source apparatus in which the units 503 of FIG. 13(A) are arranged so that six of them are arranged on the upper side while six of them are arranged on the lower side. In the light source apparatus of FIG. 13(B), the units 503 each including five LEDs that are laterally arranged are configured as described above, and are controlled in current by a single power supply to achieve desired luminance. Thus, as the light source apparatus configured to illuminate the liquid crystal panel, the light source luminance can be controlled for each emission region by each unit 503. The configuration of FIG. 13 includes a reflection surface 222 and a reflection surface 502 different from the reflection surface 222. The reflection surface 222 of these surfaces is a horizontal grid shape or a belt shape with a predetermined width.

On the other hand, the reflection surface 502 is a vertical-horizontal grid shape. The shape of the fine grid and the tilt of the divided surface are optimally designed to achieve a desired emission-light distribution (the emission direction and the diffuse property of the emission light). As a result, the light quantity and the emission direction of the light flux propagating toward the liquid crystal display panel 11 can be accurately adjusted. As a result, as similar to the two embodiments described above, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values.

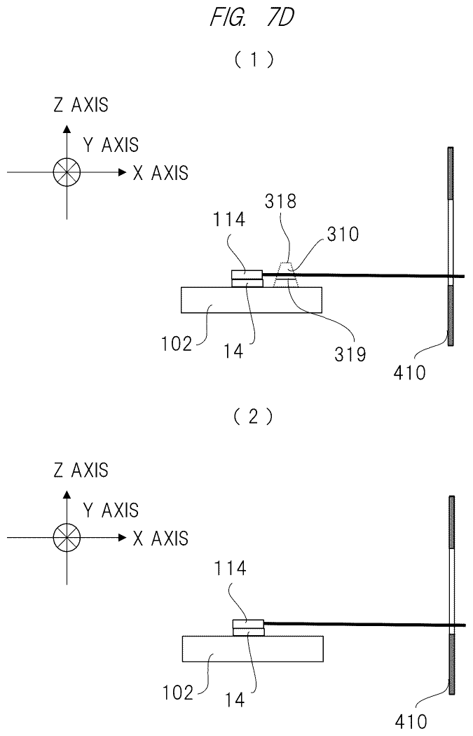

FIG. 9 is a cross-sectional view showing one example of a shape of the diffuse plate 206. As described above, the diffuse light emitted from the LED is converted to the substantially collimated light by the reflector 300 or the collimator 18, and is converted to have the specific polarized wave by the polarization converter element 21, and then, is reflected by the light guiding body. Then, the light flux having been reflected by the light guiding body is transmitted through a plane portion of a light entering surface of the diffuse plate 206, and enters the liquid crystal display panel 11 (see two solid-line arrows indicating “the reflection light emitted from the light guiding body” in FIG. 9).

The diffuse light flux of the light having been emitted from the polarization converter element 21 is totally reflected by a tilt surface of a protrusion having a tilt surface formed on the light entering surface of the diffuse plate 206, and enters the liquid crystal display panel 11. For the total reflection of the light having been emitted from the polarization converter element 21 by the tilt surface of the protrusion of the diffuse plate 206, an angle of the tilt surface of the protrusion is changed in accordance with the distance from the polarization converter element 21. When an angle of the tilt surface of the protrusion far from the polarization converter element 21 or far from the LED is set to “α” while an angle of the tilt surface of the protrusion close to the polarization converter element 21 or close to the LED is set to “α′”, α is smaller than α′ (α<α′). By such setting, the light flux having been converted in terms of the light polarization can be effectively used.

### <Technique of Controlling Diffuse Property of Video Display Apparatus>

As a method of adjusting the diffuse distribution of the video light emitted from the liquid crystal display panel 11, optimization of a shape of a lenticular lens arranged between the light source apparatus 13 and the liquid crystal display panel 11 or on the surface of the liquid crystal display panel 11 is exemplified. In other words, by the optimization of the shape of the lenticular lens, the light emission property of the video light (also referred to as “video light flux” below) unidirectionally emitted from the liquid crystal display panel 11 can be adjusted.

A micro lens array in a matrix form may be alternatively or additionally arranged on the surface of the liquid crystal display panel 11 (or between the light source apparatus 13 and the liquid crystal display panel 11) to adjust an aspect of the arrangement. In other words, by the adjustment of the arrangement of the micro lens array, the light emission property of the video light flux emitted from the video display apparatus 1 in the X-axis direction and the Y-axis direction can be adjusted, and, as a result, a video display apparatus having the desirable diffuse property can be provided.

As another configuration example, combination of two lenticular lenses may be arranged, or a sheet in which the micro lens array in the matrix form is arranged for adjusting the diffuse property may be arranged, at a position at which the video light emitted from the video display apparatus 1 passes. By such an optical system configuration, a luminance (relative luminance) of the video light in the X-axis direction and the Y-axis direction can be adjusted in accordance with the reflection angle of the video light (the reflection angle provided when the reflection in the vertical direction is set to a criterion (0 degree)).

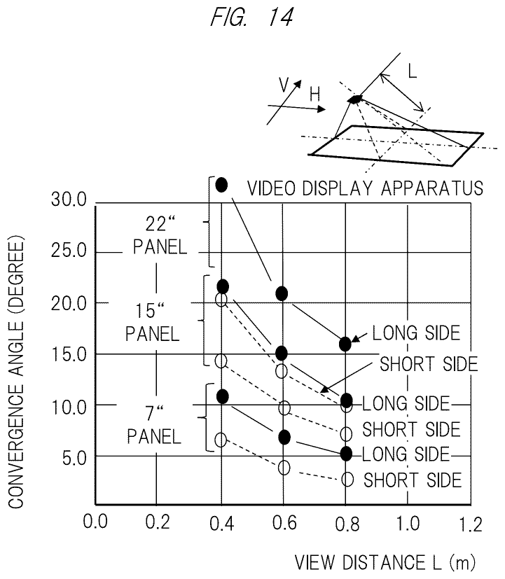

Because of use of such a lenticular lens, the present example can provide the excellent optical property as shown with the graph (plot curve) of “the Example 1 (Y-axis direction)” and “the Example 2 (Y-axis direction)” in FIG. 16(B) that is clearly different from the graph (plot curve) of the related-art property. Specifically, in the plot curve of “the Example 1 (Y-axis direction)” and “the Example 2 (Y-axis direction)”, the luminance property in the vertical direction is made sharp, and the balance of the directionality of the up and down directions (the positive and negative directions in the Y-axis direction) is changed, and, as a result, the luminance (relative luminance) of the light due to the reflection and the diffuse can be increased.

Therefore, the present example can provide the video light having the narrow diffuse angle (high rectilinear propagation) and only the specific polarized wave component as similar to the video light emitted from the surface-emitting light laser video source, can suppress the ghost image generated in the retroreflector in the case of the use of the video display apparatus of the related art, and can adjust the light so that the air floating video generated by the retroreflection efficiently reaches the eyes of the viewer.

By the light source apparatus, the diffuse property (referred to as “related-art property” in the drawings) of the light emitted from the general liquid crystal display panel as shown in FIGS. 17(A) and (B) can be provided with the directionality having the significantly narrow angle in both the X-axis direction and the Y-axis direction. Since the present example can provide such directionality having the narrow angle, the video display apparatus emitting the nearly collimated video light flux in the specific direction and emitting the light with the specific polarized wave can be achieved.

FIG. 17 shows one example of the property of the lenticular lens applied to the present example. In this example, the property in the X-axis direction (vertical direction) with respect to the Z-axis direction is particularly exemplified, and a property “O” indicates a luminance property having a peak of the light emission direction at an angle that shifts upward by nearly 30 degrees from the vertical direction (0 degree) and being symmetric in the up-and-down direction. Plot curves of a property “A” and a property “B” shown in the graph of FIG. 17 indicate property examples in which the luminance (relative luminance) is increased by collection of the upper video light of the peak luminance at nearly 30 degrees. Therefore, in these properties A and B, as seen from the comparison with the plot curve of the property O, the luminance (relative luminance) of the light is rapidly decreased in a region of an angle (θ>30°) where the tilt (angle θ) from the Z-axis direction toward the X direction exceeds 30 degrees.

In other words, according to the optical system including the lenticular lens, when the video light flux emitted from the image display apparatus 1 is caused to enter the retroreflector, the light emission angle and the viewing angle of the video light having the equalized narrow angle by the light source apparatus 13 can be adjusted, and the degree of freedom of the layout of the retroreflection sheet can be significantly improved. As a result, the degree of freedom regarding the image forming position of the air floating video formed at the desirable position after being reflected by or transmitted through the window glass can be significantly improved. As a result, the light serving as the light having the narrow diffuse angle (high rectilinear propagation) and having only the specific polarized wave component can efficiently reach the eyes of the viewer outside or inside the room. Therefore, even if the intensity (luminance) of the video light emitted from the video display apparatus 1 is decreased, the viewer can correctly recognize the video light and obtain the information. In other words, the information display system having the low power consumption because of the small output of the video display apparatus 1 can be achieved.

In the foregoing, various embodiments or examples (that are specific examples) to which the present invention is applied have been concretely described. Meanwhile, the present invention is not limited to the foregoing embodiments (specific examples), and includes various modification examples. In the above-described embodiments, for example, the entire system has been explained in detail for easily understanding the present invention, and the above-described embodiments do not always include all components explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

The light source apparatus described above is also applicable to not only the air floating video display apparatus but also an information display apparatus such as HUD, tablet, and digital signage.

In the techniques according to the present embodiments, the air floating video is displayed in a state where the high-resolution and high-luminance video information is aerially floated, and, as a result, for example, the user can perform operations without concern about contact infection in illness. When the techniques according to the present embodiments are applied to the system that is used by a large number of unspecified users, a contactless user interface having the less risk of the contact infection in illness and being available without the concern can be provided. The present invention providing such a technique contributes to “the third goal: Good Health and Well-being (for all people)” of the sustainable development goals (SDGs) advocated by the United Nations.

And, since only the normal reflection light is efficiently reflected with respect to the retroreflector by the techniques according to the present embodiments of making the divergence angle of the emitted video light small and making the equalized specific polarized wave, the light use efficiency is high, and the bright and clear air floating video can be provided. The techniques according to the present embodiments can provide a contactless user interface being excellent in availability and capable of significantly reducing the power consumption. The invention providing such a technique contributes to “the ninth goal: Industry, Innovation and Infrastructure” and “the eleventh goal: Sustainable Cities and Communities” of the sustainable development goals (SDGs) advocated by the United Nations.

Further, the techniques according to the present embodiments can form the air floating video made of the video light having the high directionality (rectilinear propagation). In the techniques according to the present embodiments, even in case of display of the video that requires the high security in an ATM at bank, a ticketing machine at station and so forth or display of the video having high confidentiality that needs to be confidential to a person who faces the user, the display of the video light having the high directionality can provide a contactless user interface having the less risk of the peek at the air floating video by the person different from the user. The present invention provides the above-described techniques, and therefore, contributes to “the eleventh goal: Sustainable Cities and Communities” of the sustainable development goals (SDGs) advocated by the United Nations.

### EXPLANATION OF REFERENCE CHARACTERS

1 . . . video display apparatus, 2 . . . first retroreflector, A1, A2, A3, 220A, 220B, 204 . . . air image (air floating image), 110 . . . first light-transmittable plate, 111 . . . reflection-type polarizer sheet (reflection-type polarizer), 13 . . . light source apparatus, 54 . . . light-direction converter panel, 105 . . . linear Fresnel sheet, 107 . . . . Rotational mechanism, 102 . . . absorption-type polarizer sheet (absorption-type polarizer), 200 . . . plane display, 201 . . . housing, 203 . . . sensing system, 226 . . . sensing area, 102 . . . substrate, 11 and 335 . . . liquid crystal display panel, 206 . . . diffuse plate, 21 . . . polarization converter element, 300 . . . reflector, 213 . . . λ/2 plate, 306 . . . reflection-type light guiding body, 307 . . . reflection surface, 308 and 310 . . . sub-reflector, 204 . . . air floating video, 334 . . . video light control sheet, 336 . . . light-transmittable portion, 337 . . . light absorbing portion, 81 . . . optical element, 501 . . . polarization converter element, 503 . . . unit, 507 . . . light shielding wall, 401 and 402 . . . light shielding plate, 320 . . . base material, 511 . . . housing, 512 . . . support arm, 513 . . . hinge, 514 . . . back cover, 515 . . . housing cover, 516 . . . housing base, 517 and 518 . . . tilted linear Fresnel sheet, 519 . . . eccentric Fresnel sheet

1.-15. (canceled)

16. An air floating video information display system comprising:
a display panel configured to emit video light;
a light source apparatus configured to supply light to the display panel;
a retroreflector configured to cause video light of specific polarized wave emitted from the display panel to aerially display an air floating video of a real image; and
a polarization converter arranged on a surface of the retroreflector and configured to convert video light of specific polarized wave into light of other polarized wave,
wherein a first light-transmittable plate including a light-polarization beam splitter arranged between the display panel and the retroreflector and configured to transmit the video light of the specific polarized wave, and to reflect the converted video light of the other polarized wave after being reflected on the retroreflector,
the converted video light of the other polarized wave after being reflected on the retroreflector is caused to enter in a direction substantially vertical to an optical axis connecting the display panel and the retroreflector facing thereto, and
the reflected video light aerially displays an air floating video of a real image after being transmitted through a second light-transmittable plate arranged on an opening of a housing for the air floating video information display system.

17. The air floating video information display system according to claim 16,
wherein the display panel, the light source apparatus, the retroreflector and the first light-transmittable plate are included in the housing, and
a part of the housing has a configuration to be connected to the air floating video information display system by a connection member.

18. The air floating video information display system according to claim 16,
wherein a distance between the display panel and the first light-transmittable plate is changed.

19. The air floating video information display system according to claim 16,
wherein the first light-transmittable plate is fixed to the housing through an elastic member.

20. The air floating video information display system according to claim 19,
Wherein a light emitting portion and a light receiving portion of a sensing system for interaction in response to operation on the air floating video are arranged inside the housing.

21. The air floating video information display system according to claim 16,
wherein the light source apparatus includes:
a point-type or surface-type light source;
a reflector configured to reflect light emitted from the light source; and
a light guiding body configured to guide the light emitted from the reflector toward the display panel, and
a reflection surface of the reflector has an asymmetric shape across an optical axis of the light emitted from the light source.

22. The air floating video information display system according to claim 21,
wherein the light guiding body is a reflection-type light guiding body.

23. The air floating video information display system according to claim 21, further comprising:
a diffuse plate configured to diffuse light guided from the light guiding body; and
a sidewall arranged to sandwich a space between the light guiding body and the diffuse plate.

24. The air floating video information display system according to claim 22, further comprising:
a diffuse plate configured to diffuse light guided from the light guiding body; and
a sidewall arranged to sandwich a space between the light guiding body and the diffuse plate.

25. The air floating video information display system according to claim 21,
wherein a plastic material, a glass material or a metal material is used for the reflector.

26. An air floating video information display system comprising:
a display panel configured to display a video;
a light source apparatus; and
a retroreflector configured to reflect video light emitted from the display panel and to cause the reflected light to aerially display an air floating video of a real image,
wherein the light source apparatus includes:
a point-type or surface-type light source;
a reflector configured to reflect light emitted from the light source; and
a light guiding body configured to guide light emitted from the reflector toward the display panel,
a light-source light reflection surface of the light guiding body has a configuration in which a plurality of reflection surfaces are arranged in a direction vertical to an optical axis along which light-source light propagates, to adjust an emission direction and a diffuse angle of the light-source light entering the display panel in accordance with a tilt angle of each of the reflection surfaces, and
a video display apparatus configured to control an emission direction and a diffuse angle of the light emitted from the display panel is arranged, and
an emission direction and a diffuse angle of video light of the air floating video are adjusted.

27. An air floating video information display system comprising:
a display panel configured to display a video;
a light source apparatus for the display panel; and
a retroreflector configured to reflect video light emitted from the display panel and to cause the reflected light to aerially display an air floating video of a real image,
the display panel, the light source apparatus and the retroreflector being included in the same housing,
wherein the housing includes a support member, and
a hinge is provided to be fixed to the support member and a housing base of the air floating video information display system, and
the housing has a configuration in which an emission direction of video light of the air floating video can be changed by the hinge provided on the housing base.

28. The air floating video information display system according to claim 27,
wherein the light source apparatus includes:
a point-type or surface-type light source;
a reflector configured to reflect light emitted from the light source; and
a light guiding body configured to guide light emitted from the reflector toward the display panel, and
a reflection surface of the reflector has an asymmetric shape across an optical axis of the light emitted from the light source.

29. The air floating video information display system according to claim 28,
wherein the light guiding body is a reflection-type light guiding body.

30. The air floating video information display system according to claim 28, further comprising:
a diffuse plate configured to diffuse light guided from the light guiding body; and
a sidewall arranged to sandwich a space between the light guiding body and the diffuse plate.

31. The air floating video information display system according to claim 28,
wherein a plastic material, a glass material or a metal material is used for the reflector.
